(19) United States
(12) Patent Application Publication
(10) Pub. No.: US 2013/0283273 A1
(43) Pub. Date: Oct. 24, 2013

(54) SERVICE RESERVATION MANAGEMENT METHOD, VIRTUAL MACHINE SYSTEM AND STORAGE MEDIUM

(71) Applicant: Hirohisa Miyazaki, Kawasaki (JP)

(72) Inventor: Hirohisa Miyazaki, Kawasaki (JP)

(21) Appl. No.: 13/978,016

(22) PCT Filed: Jan. 5, 2011
(86) PCT No.: PCT/JP2011/050032

§ 371 Date: Jul. 2, 2013

(51) Int. Cl. G06F 9/455

(52) U.S. Cl. CPC G06F 9/45533
USPC 718/1

(57) ABSTRACT

Provided is a service reservation management method for a plurality of physical computers, at least one virtual machine, which is provided by a virtualizing part, and a management computer for managing a service allocated to the at least one virtual machine and the virtualizing part, the method including: receiving, by the management computer, a reservation of a service; searching, by the management computer, for a combination of the received service and a service stored in a reservation information by referring to service combination information for storing a combination of services that has a chance of causing an anomaly in one of the plurality of physical computers; and outputting, by the management computer, when the service combination information includes the combination of the received service and the service stored in the reservation information, an alert indicating that the combination has a chance of causing an anomaly.

### BACKGROUND

This invention relates to reserving physical computer resources in a virtual computer system, and more particularly, to a technology of controlling a combination of services to be run on a physical computer when a plurality of services are executed on virtual machines.

A business operation system that uses a virtualized environment executes types of processing that meet requests from users by running a plurality of services successively, or by running a plurality of services in parallel on a plurality of virtual machines. A service is, for example, a business operation that is provided by an application processed on one of virtual machines which respectively process applications, or a service provided by a database system or a Web server. The business operation system processes requests from users by combining a plurality of types of services as these and executing the combination of services on a virtual computer system.

This type of business operation system runs on one physical server or a plurality of physical servers, and each individual service is executed on one virtual machine which runs on one physical server. In the virtual machine environment that provides the business operation system, a hypervisor (virtualizing part) manages and controls a plurality of virtual machines. Specifically, the hypervisor executes and shuts down the virtual machines, and allocates resources such as a processor and a memory to the virtual machines. The hypervisor is also capable of dynamically changing the allocation amount of a processor, memory, and other resources to be used by a virtual machine that is running. The dynamic distribution of computer resources by a hypervisor is known as, for example, Dynamic Logical Partitioning.

In the case where a plurality of services constituting this type of business operation system are respectively run on a plurality of virtual machines, resources to be used are reserved so that computer resources are secured. In Japanese Patent Application Laid-open No. 2004-302748, for example, there is disclosed a technology of making reservation in order to secure resources to be used in virtual machines.

In the case where a plurality of virtual machines are run on one physical computer, resources may become short when the plurality of virtual machines are actually run and requests from users increase in number to an unexpectedly high level, causing the dynamic allocation change described above to be executed depending on the load of the respective virtual machines. When resources become short, the hypervisor is capable of migrate one of the running virtual machines to another physical server with the use of a hot migration function. Migrating the virtual machine to another physical computer frees up the resources that have been used, and are secured as free resources by the hypervisor. The free resources are reallocated to another virtual machine that have become short of resources, thereby solving the shortage of resources.

For resource reallocation for the purpose of solving a shortage of resources, in Japanese Patent Application Laid-open No. 2004-199561, for example, there is disclosed a technology of allocating resources in a manner that avoids a shortage the amount of resources. Specifically, the disclosed technology determines the amount of resources by calculating a correlation about the resource utilization state from the past execution history and, when resources become short, changes allocation dynamically based on the calculated resource amount.

### SUMMARY

However, even when virtual machines are run based on the amounts of reserved resources, the change in the number of processing requests with regard to services executed on the virtual machines varies depending on the mode and utilization form of the services. In the case where a plurality of business operation systems are executed on virtual machines of the same physical server, in particular, what services are run simultaneously on one business operation system and another business operation system needs to be taken into account.

For instance, consider a case where a service A run on a business operation system A and a service B run on a business operation system B are allocated to a virtual machine a and a virtual machine b, and executed concurrently on the same physical server. During the concurrent execution of the service A and the service B, processing requests to the service B may increase in number to an unexpectedly high level, causing a shortage of resources in the virtual machine for the service B. This shortage of resources can be solved by evacuating the virtual machine a for the service A to another physical server through hot migration and reallocating resources that have been used for the service A to the virtual machine b, which executes the service B.

An accidental fluctuation as this, however, cannot be predicted and taken into account with a reservation system. For instance, with the resource reservation in Japanese Patent Application Laid-open No. 2004-302748, it is difficult to solve a shortage of resources for the service after the service is started.

In addition, the load on the network between the migration source physical computer and the migration destination physical computer is heavy in the hot migration described above. Hot migration on a physical computer that is short of resources and accordingly is heavy in load is therefore desirably avoided.

In Japanese Patent Application Laid-open No. 2004-199561, the performance deficiency of a physical computer is kept track of from the execution history, which is based on the premise that a service executed by a virtual machine is run fixedly on a particular physical computer. By executing a service fixedly on a particular physical computer, a performance deficiency can be identified from the past execution history and an appropriate amount of resources can be determined. However, when reservations are made for a plurality of business operation systems with the reservation system, the reservation system is allowed to dispose services freely and flexibly from among an appropriate combination of resource amounts necessary to execute services. In other words, arranging services based on the reservation system means that the combination of services that run at the same time is not always the same. The resultant problem is that an appropriate amount of resources determined by keeping track of performance from the past execution history cannot be made use of in other environments than the one for executing the same combination of services as that of the measured execution history. In the case of a virtual machine environment where the combination of services is changed based on a reservation system, in particular, which physical computer executes a service changes depending on the resource situation in the computer system, with the result that making use of the past execution history is difficult.

This invention has been made in view of the problems described above, and an object of this invention is therefore to prevent a shortage of physical computer resources through how services are combined when a plurality of services are executed on a plurality of virtual machines.

A representative aspect of this invention is as follows. A service reservation management method for a plurality of physical computers, each of which comprises a processor and a memory, at least one virtual machine, which is provided by a virtualizing part executed on each of the plurality of physical computers, and a management computer for managing a service allocated to the at least one virtual machine and the virtualizing part, the method comprising: a first step of receiving, by the management computer, a reservation of a service; a second step of searching, by the management computer, for a combination of the received service and a service of reservation information in which a service that has been already reserved is stored, by referring to service combination information for storing a combination of services that has a chance of causing an anomaly in one of the plurality of physical computers; and a third step of outputting, by the management computer, when the service combination information comprises the combination of the received service and the service stored in the reservation information, an alert indicating that the combination has a chance of causing an anomaly.

According to this invention, the combination of services that has caused the anomaly such as a shortage of resources in the past is stored in service combination information, which enables the management computer to output the alert for the combination that causes the shortage of resources when the services are newly reserved. A combination of services that does not have a chance of causing an anomaly in the physical computers such as a shortage of resources can thus be configured, and a reservation that appropriately disposes services among the physical computers is accomplished.

### BRIEF DESCRIPTION OF THE DRAWINGS

FIG. 1 is a block diagram illustrating an example of the configuration of a virtual computer system according to the embodiment of this invention.

FIG. 2 is a block diagram illustrating function elements of the management program which is executed on the management server according to the embodiment of this invention.

FIG. 3 is a block diagram illustrating function elements of a program that is executed on the physical servers according to the embodiment of this invention.

FIG. 4 is a diagram illustrating an example of the physical server configuration table according to the embodiment of this invention.

FIG. 5 is a diagram illustrating an example of the virtual machine configuration table according to the embodiment of this invention.

FIG. 6 is a diagram illustrating an example of the service list table according to the embodiment of this invention.

FIG. 7 is a diagram illustrating an example of the template list table according to the embodiment of this invention.

FIG. 8 is a diagram illustrating an example of the reservation table according to the embodiment of this invention.

FIG. 9 is a diagram illustrating an example of the service combination table according to the embodiment of this invention.

FIG. 10 is a diagram illustrating an example of the time segment list 250 of the physical server #1 according to the embodiment of this invention.

FIG. 11 illustrates an allocation determining table of the physical server 2-1 (physical server #1) according to the embodiment of this invention.

FIG. 12 illustrates an allocation determining table of the physical server 2-2 (physical server #2) according to the embodiment of this invention.

FIG. 13 illustrates an allocation determining table of the physical server 2-3 (physical server #3) according to the embodiment of this invention.

FIG. 14 illustrates an evaluation result table of the physical server 2-1 (physical server #1) according to the embodiment of this invention.

FIG. 15 illustrates an evaluation result table of the physical server 2-3 (physical server #3) according to the embodiment of this invention.

FIG. 16 is a diagram illustrating an example of the allocation destination evaluation value table according to the embodiment of this invention.

FIG. 17 is a diagram outlining processing of this invention.

FIG. 18 is a flow chart illustrating an example of processing that is executed in the resource monitoring part according to the embodiment of this invention.

FIG. 19 is a flow chart illustrating an example of processing that is executed by the template management part according to the embodiment of this invention.

FIG. 20 illustrates reservation request information according to the embodiment of this invention.

FIG. 21 is a screen image illustrating an example of the template selecting screen according to the embodiment of this invention.

FIG. 22 is a flow chart illustrating an example of reservation processing which is executed in the reservation management part according to the embodiment of this invention.

FIG. 23 is a flow chart illustrating an example of the allocation destination candidate searching processing which is executed in Step S122 of FIG. 22.

FIG. 24 illustrates an allocation destination candidate according to the embodiment of this invention.

FIG. 25 illustrates a reservation situation where the physical server 2 for which a time segment reserved in the reservation table according to the embodiment of this invention.

FIG. 26 is a flow chart illustrating an example of the processing of obtaining the time segment list 250 which is executed in Step S133 of the allocation destination candidate searching processing of FIG. 23.

FIG. 27 illustrates time segment lists of the reservation request time segment of the respective physical servers 2 according to the embodiment of this invention.

FIG. 28 is a flow chart illustrating an example of the allocation destination candidate evaluating processing which is executed in Step S125 of FIG. 22.

FIG. 29 illustrates an example of the evaluation value table according to the embodiment of this invention.

FIG. 30 illustrates an example of the evaluation value for resource shortage according to the embodiment of this invention.

### DETAILED DESCRIPTION OF THE PREFERRED EMBODIMENT

An embodiment of this invention is described below with reference to the accompanying drawings.

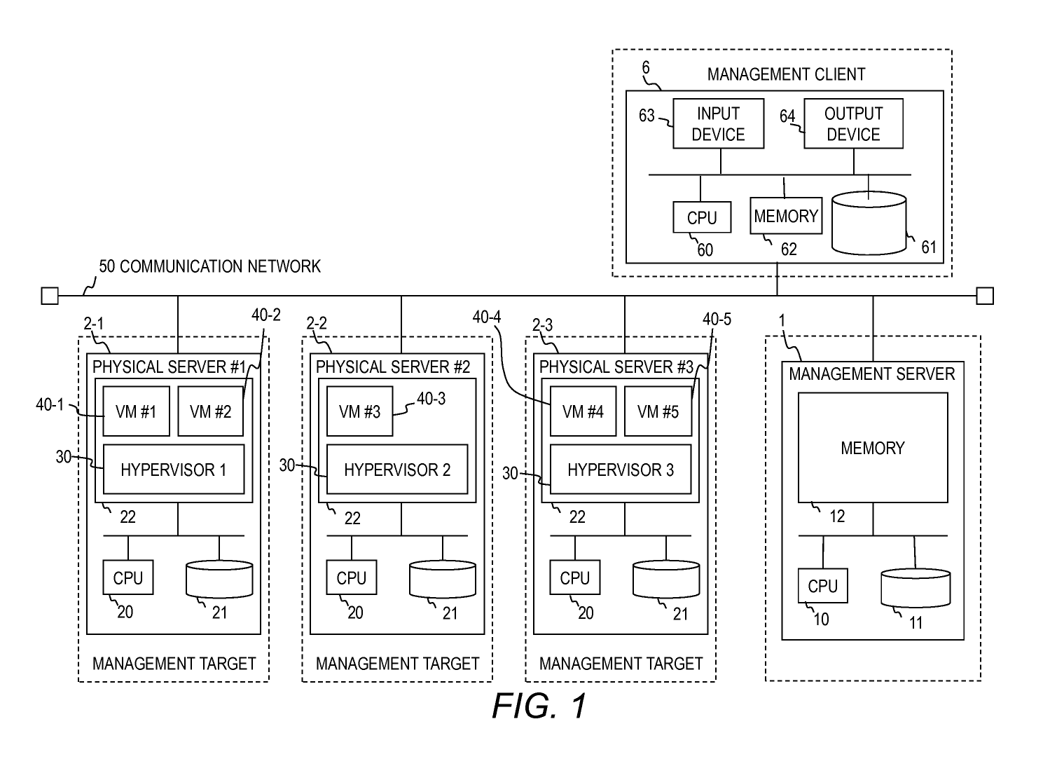

FIG. 1 is a block diagram illustrating an example of the configuration of a virtual computer system according to the embodiment of this invention. The virtual computer system mainly includes physical servers 2-1 to 2-3, which provide a plurality of virtual machines 40-1 to 40-5, a management server 1, which manages these physical servers 2-1 to 2-3 as management targets, a management client 6, which gives an instruction to the management server 1, and a communication network 50, which connects the physical servers 2-1 to 2-3, the management server 1, and the management client 6. The physical servers 2-1 to 2-3 have the same configuration. In the following description, the physical servers 2-1 to 2-3 are collectively referred to as physical servers 2 and the virtual machines 40-1 to 40-5 are collectively referred to as virtual machines 40.

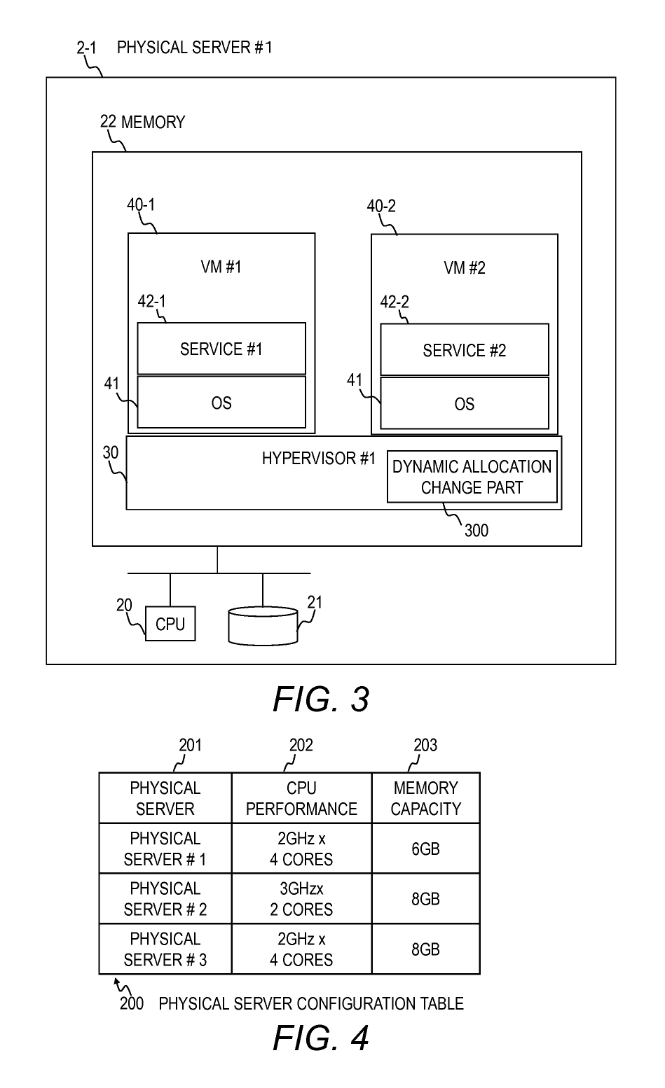

The physical servers 2 are each a physical computer that includes a processor 20, a memory 22, and a storage device 21. Hypervisors 30 are executed on the respective physical servers 2 to provide the plurality of virtual machines 40. The hypervisors 30 divide physical resources of the physical servers 2 for allocation among logical partitions so that the virtual machines 40 are executed in the respective logical partitions. The hypervisors 30 include a dynamic logical partitioning function for dynamically changing resources of the physical servers 2 that are allocated to the logical partitions. When a service or the like that is being executed on one of the virtual machines 40 requires more resources, the relevant hypervisor 30 can add or change resources allocated to the virtual machine 40 that is executing the service. For instance, when the load on one of the virtual machines 40 increases, a dynamic logical partitioning part 300 (see FIG. 3) of the relevant hypervisor 30 automatically allocates unallocated resources (CPUs and memories) to the virtual machine 40 that has increased in load.

In the example of FIG. 1, the hypervisor 30 of the physical server 2-1 provides the virtual machines 40-1 and 40-2 (VM1 and VM2), the hypervisor 30 of the physical server 2-2 provides the virtual machine 40-3 (VM3), and the hypervisor 30 of the physical server 2-3 provides the virtual machines 40-4 and 40-5 (VM4 and VM5). The respective virtual machines 40 provide services to user terminals (not shown) via the communication network 50. The hypervisor 30 of each physical server 2 sends a given alert to the management server 1 when a trouble such as a shortage of resources of the physical server 2 occurs.

The management server 1 is a physical computer that includes a processor 10, a memory 12, and a storage device 11. The management server 1 reads a management program out of the storage device 11 onto the memory 12, and executes the management program with the processor 20 to manage the plurality of physical servers 2 in a manner described later. The storage device 11 also functions as a non-transitory storage medium having the management program stored thereon.

The management client 6 is a physical computer that includes a processor 60, a memory 62, a storage device 61, an input device 63, and an output device 64. The management client 6 is used by an administrator of the virtual computer system or the like. The administrator or the like enters instructions and settings to the management server 1 via the input device 63. The management client 6 then displays information received from the management server 1 on the output device 64. The administrator makes requests to the management server 1 through the management client 6 in order to, for example, obtain the configuration information of the physical servers 2, reserve services executed on the virtual machines 40, or reserve the virtual machines 40.

<Configuration of the Management Server>

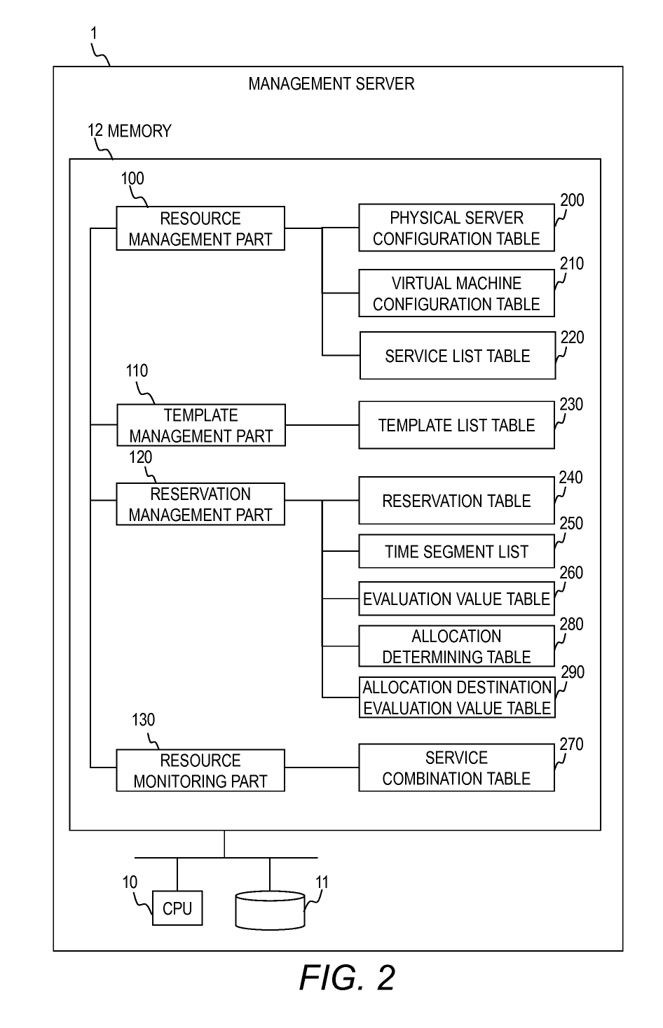

FIG. 2 is a block diagram illustrating function elements of the management program which is executed on the management server 1. The program for managing the physical servers 2 mainly includes a resource management part 100, a template management part 110, a reservation management part 120, a resource monitoring part 130, and various tables 200 to 290.

Based on requests from the management client 6 or the reservation management part 120, the resource management part 100 controls the virtual machines 40-1 to 40-5 and services executed on the physical servers 2-1 to 2-3. The resource management part 100 obtains configuration information from the hypervisor 30 of each physical server 2 to store the table 200, which is a physical server configuration table, and the table 210, which is a virtual machine configuration table, in the memory 12. The resource management part 100 also stores in the memory 12 the table 220, which is a service list table for managing the types of services executed on the virtual machines 40.

The resource monitoring part 130 receives an alert indicating a shortage of resources or the like from the hypervisor 30 of one of the physical servers 2. The resource monitoring part 130 then stores, in the table 270, which is a service combination table, the combination of services that are being executed on the relevant virtual machine 40 of this physical server 2 and resource information. The service combination table 270 accumulates, as a history, combinations of services that have been run when a shortage of resources or other anomalies have occurred in the physical servers 2 and a resource state. In other words, the service combination table 270 holds a combination of services that have a chance of causing an anomaly such as a shortage of resources when executed concurrently on the physical server 2 in question.

The reservation management part 120 receives service reservation request information 310 from the management client 6 and stores the reservation request information in the table 240, which is a reservation table (reservation information). When a start time contained in the reservation table 240 is reached, the reservation management part 120 requests the resource management part 100 to execute this service on the relevant virtual machine 40. When an end time contained in the reservation table 240 is reached, the reservation management part 120 requests the resource management part 100 to end the service and the virtual machine 40.

The reservation management part 120 stores in the memory 12 the table 250, which is a time segment list for determining a running term (or reservation term) of a service in order to reserve the virtual machine 40 that is to execute the service on one of the physical services 2, the table 260, which is an evaluation result table for evaluating combinations of services executed on the physical servers 2, the table 280, which is an allocation determining table for determining whether or not a service to be reserved is executable, and an allocation destination evaluation value table 290.

The reservation management part 120 receives a reservation request (the service reservation request information 310) from the management client 6, and selects which of the physical servers 2-1 to 2-3 executes which of reserved services so that the combination of services reserved for the virtual machines 40 of the physical servers 2 does not match any service combination recorded in the service combination table 270 as a combination of services that have caused a shortage of resources.

The template management part 110 generates a template that associates a service executed by one of the virtual machines 40 with the amount of resources required (a required allocation amount) for the virtual machine 40, and stores the template in the template list table 230.

When receiving a reservation for a service from the management client 6, the reservation management part 120 simplifies service reservation by presenting the template list table 230 to the administrator and letting the administrator select a template. In other words, the administrator who operates the management client 6 can automatically configure the amount of resources required by the relevant virtual machine 40 to execute a desired service by simply selecting the service from a template. This saves the administrator the trouble of configuring the amount of resources necessary in the relevant virtual machine 40 for each service reservation, and enables the administrator to make a reservation for a service with efficiency.

Details of the processing of the management program and the details of the respective tables are described later.

<Configuration of the Physical Servers>

FIG. 3 is a block diagram illustrating function elements of a program that is executed on the physical servers 2. Because the physical servers 2-1 to 2-3 have the same configuration, the physical server 2-1 is described while omitting descriptions on the other physical servers, 2-2 and 2-3.

The processor 20 executes the hypervisor 30 after reading the hypervisor 30 out of the storage device 21 onto the memory 22. The hypervisor 30 receives from the management server 1 an instruction to start executing services, and allocates instructed amounts of resources from the physical resources of the physical server 2-1 to logical partitions that execute the virtual machines 40. The hypervisor 30 then activates the virtual machines 40-1 and 40-2 to execute OSs 41 on the respective virtual machines 40 and to execute services 42-1 and 42-2 instructed by the management server 1 on the OSs 41 of the virtual machines 40, respectively. The OSs 41 and the services 42-1 and 42-2 are read out of the storage device 21 or out of the storage device 11 of the management server 1. In the following description, the services 42-1 (service #1) and 42-2 (service #2) are collectively referred to as services 42.

The services 42 executed on the respective virtual machines 40 are provided to clients by executing programs. The programs of the services 42 are executed in one of forms selected from among application, daemon, and service.

As described above, the hypervisor 30 includes the dynamic logical partitioning part 300, which dynamically changes the allocated amount of resources to accommodate a change in load on the virtual machines 40. The configuration of the dynamic logical partitioning part 300 can be a well-known or publicly-known one and is not described in detail here.

<Configurations of the Respective Tables>

Details of the respective tables used by the management server 1 are described below.

FIG. 4 is a diagram illustrating an example of the physical server configuration table 200 which is managed by the resource management part 100. One entry of the physical server configuration table 200 includes a field for a physical server 201 for storing the identifier of one of the physical servers 2, a field for CPU performance 202 for storing the performance of the processor 20 of the physical server 2, and a field for a memory capacity 203 for storing the capacity (GB) of the memory 22 installed in the physical server 2. The field for the CPU performance 202 stores the operating frequency (GHz) and core count of the processor 20.

The resource management part 100 obtains configuration information of each physical server 2 from the relevant hypervisor 30 in given cycles (for example, every hour) to update the physical server configuration table 200.

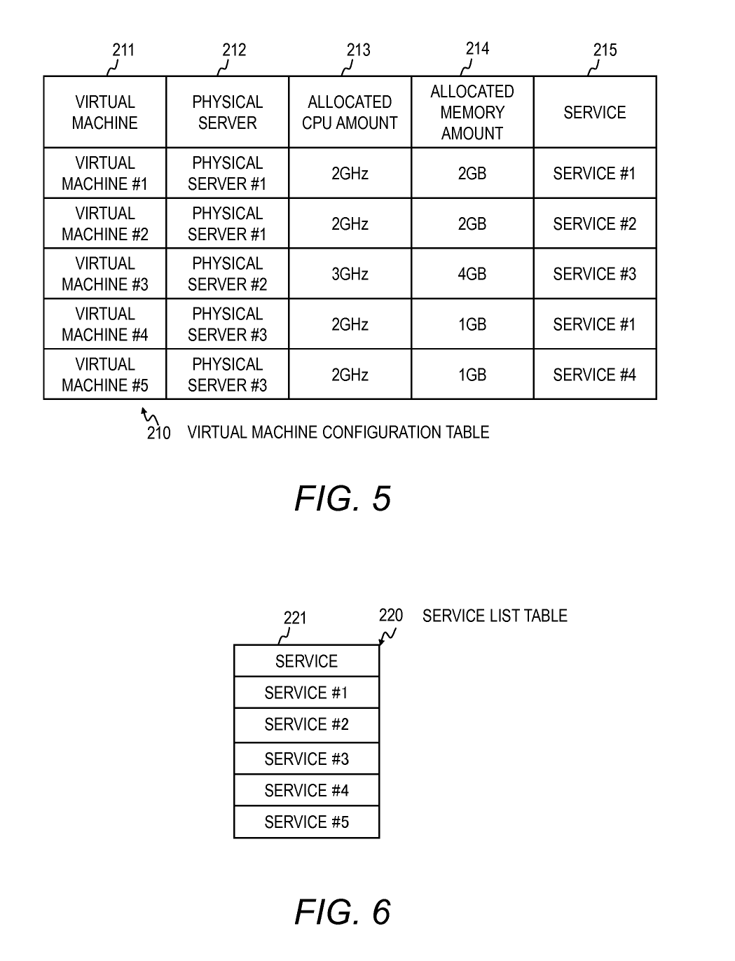

FIG. 5 is a diagram illustrating an example of the virtual machine configuration table 210 which is managed by the resource management part 100. One entry of the virtual machine configuration table 210 includes a field for a virtual machine 211 for storing the identifier of one of the virtual machines 40, a field for a physical server 212 for storing the identifier of the physical server 2 where the virtual machine 40 is run, a field for an allocated CPU amount 213 for storing the allocated amount of the processor 20 that is allocated to the virtual machine 40, a field for an allocated memory amount 214 for storing the allocated amount of the memory 22 that is allocated to the virtual machine 40, and a field for a service 215 for storing the identifier of the service 42 that is executed on the virtual machine 40. A value obtained by multiplying the count of cores of the processor 20 that are allocated to the virtual machine 40 by the operating frequency (GHz) is configured as the allocated amount in the field for the allocated CPU amount 213.

The resource management part 100 obtains configuration information of each virtual machine 40 from the relevant hypervisor 30 in given cycles (for example, every minute) to update the virtual machine configuration table 210.

FIG. 6 is a diagram illustrating an example of the service list table 220 which is managed by the resource management part 100. One entry of the service list table 220 is configured from a field for a service 221 for storing the identifier of one of the services 42. The service list table 220 stores information configured by the administrator through the management client 6.

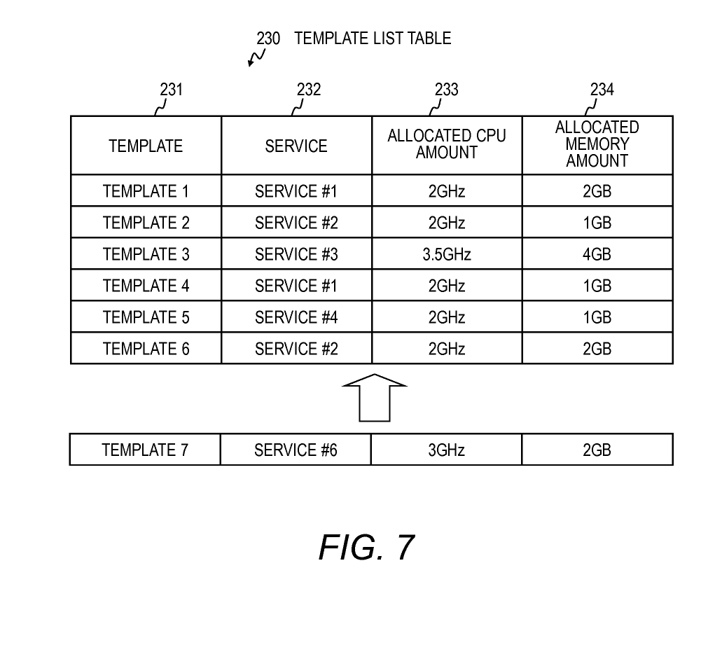

FIG. 7 is a diagram illustrating an example of the template list table 230 which is managed by the template management part 110. One entry of the template list table 230 is configured from a field for a template 231 for storing the identifier of a template, a field for a service 232 for storing the identifier of the service 42 that is defined in the template, a field for an allocated CPU amount 233 for storing the allocated amount of the processor 20 that is needed by the virtual machine 40 that executes the service 42, and a field for an allocated memory amount 234 for storing the allocated amount of the memory 22 that is needed by the virtual machine 40 that executes the service 42. The template list table 230 stores information configured by the administrator through the management client 6.

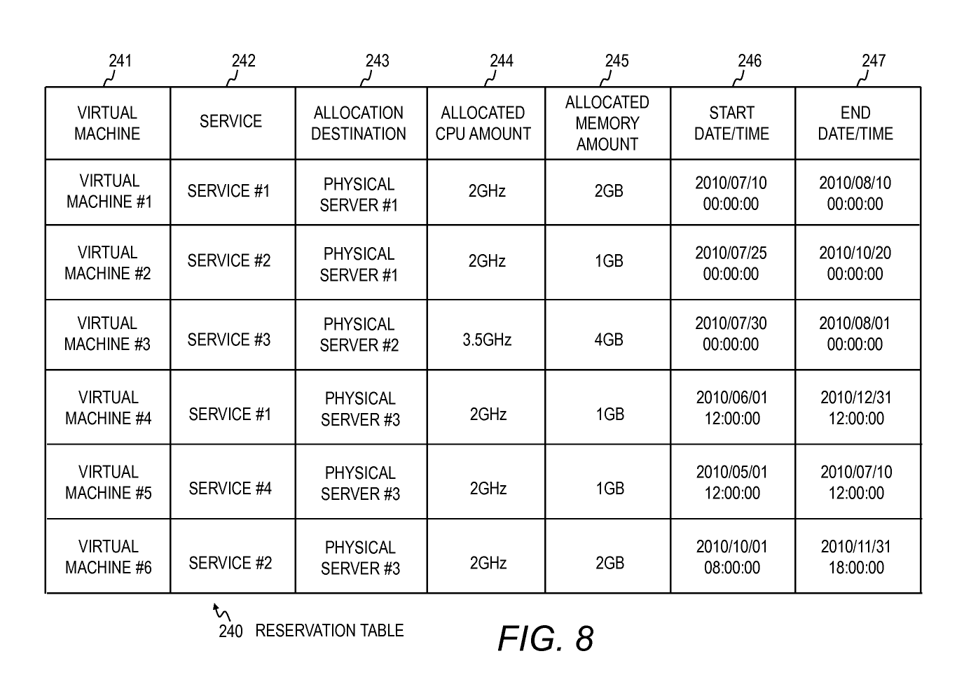

FIG. 8 is a diagram illustrating an example of the reservation table 240 which is managed by the reservation management part 120. One entry of the reservation management table 240 is configured, as reservation information, from a field for a virtual machine 241 for storing the identifier of the virtual machine 40 to which a reserved service is allocated, a field for a service 242 for storing the identifier of the reserved service, a field for an allocation destination 243 for storing the identifier of the physical server 2 to which the virtual machine 40 that executes the service is allocated, a field for an allocated CPU amount 244 for storing the allocated amount of the processor 20 that is allocated to the virtual machine 40, a field for an allocated memory amount 245 for storing the allocated amount of the memory 22 that is allocated to the virtual machine 40, a field for a start date/time 246 for reserving the date/time at which the service is started, and a field for an end date/time 247 for reserving the date/time at which the service is ended. The reservation table 240 stores a value obtained by adjusting, in the reservation management part 120, in a manner described below, reservation information about a reservation requested from the management client 6.

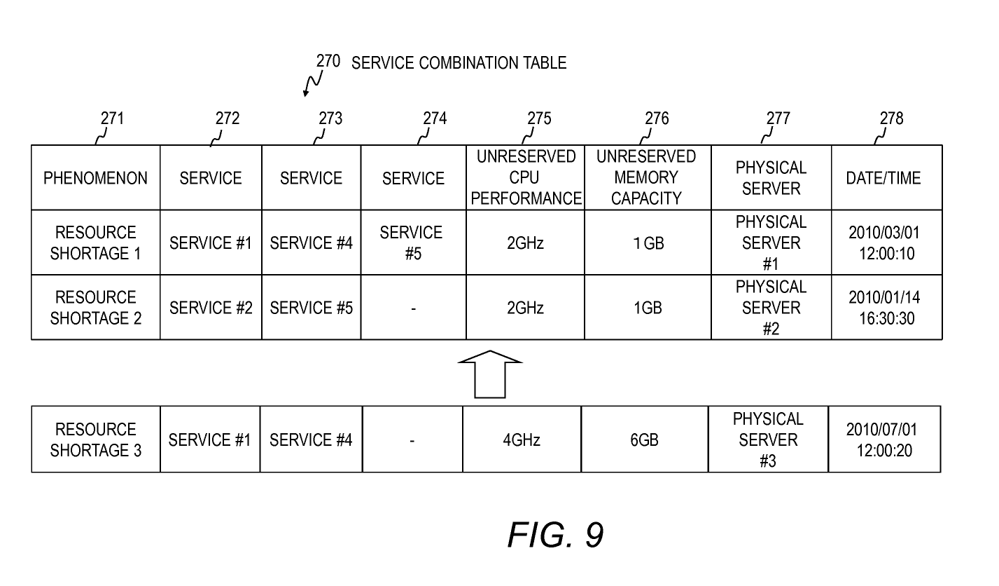

FIG. 9 is a diagram illustrating an example of the service combination table 270 which is managed by the resource monitoring part 130. One entry of the service combination table 270 is configured, as history information about a history of failures such as a shortage of resources, from a field for a phenomenon 271 for storing information that is the details of an alert received from one hypervisor 30 plus the identifier, fields for services 272, 273, and 274 for storing the identifiers of the services 42 that are being executed on the relevant physical server 2, a field for unreserved CPU performance 275 for storing the allocated amount of the processor 20 that is not reserved for use at the time of the phenomenon 271, a field for an unreserved memory capacity 276 for storing the allocated amount of the memory 22 that is not reserved for use at the time of the phenomenon 271, a field for a physical server 277 for storing the identifier of the physical server 2 where the phenomenon 271 has occurred, and a field for a date/time 278 for storing the date/time of the phenomenon 271.

The resource monitoring part 130 receives an alert from one hypervisor 30, obtains resource information of the relevant physical server 2 and virtual machine 40 from the hypervisor 30 that has transmitted the alert, and adds a new entry to the service combination table 270. While the number of the services 42 that are being executed on the physical server 2 is three and the identifiers of the services are stored in the fields for the services 272 to 274 in the illustrated example, the number of the service fields can be configured so as to match the number of the services 42 that are executed on one physical server 2.

The service combination table 270 may also be provided with a field for storing the amount of resources of the relevant physical server 2 that are an excess at the time of the phenomenon 271. For instance, in the case where a field for storing the unallocated CPU performance and a field for storing the unallocated memory capacity are provided, which of the CPU resources and the memory resources have become short at the time of the phenomenon 271 can be recorded.

The amount of unreserved resources (CPU performance or memory capacity) refers to the amount of resources that are not specified in the reservation table 240 among the resources of the relevant physical server 2. For instance, the unreserved memory capacity 276 is a value calculated by subtracting the sum of the relevant memory capacities 245 that are configured in the reservation table 240 at the date/time 278 from the memory capacity 203 of the physical server 277, and is a memory capacity that is not reserved for use.

The amount of unallocated resources, on the other hand, refers to the amount of resources that are not allocated to the virtual machines 40 among resources of the relevant physical server 2 that can be allocated by the hypervisor 30. For instance, the unallocated memory capacity is a memory capacity calculated by subtracting the memory capacity that is actually in use from the memory capacity 203 that can be allocated by the hypervisor 30.

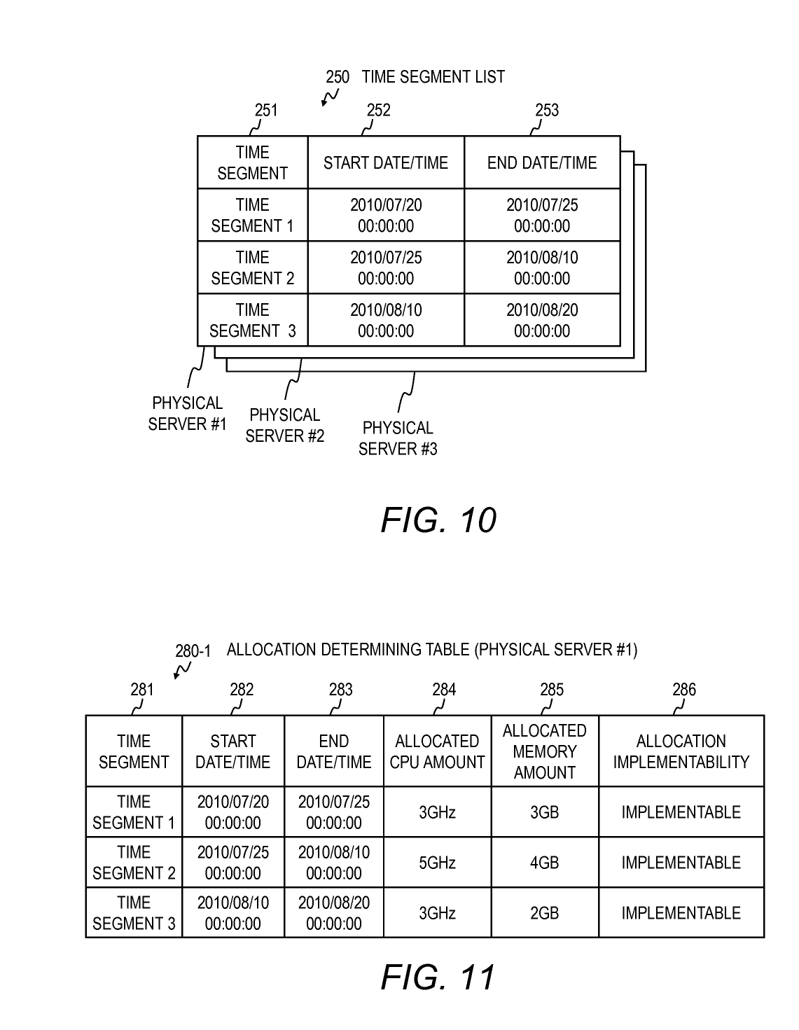

FIG. 10 is a diagram illustrating an example of the time segment list 250 of the physical server #1 which is managed by the reservation management part 120. One entry of the time segment list 250 is configured from a field for a time segment 251 for storing the identifier of a time segment, a field for a start date/time 252 for storing the start date/time of the time segment, and a field for an end date/time 253 for storing the end date/time of the time segment. The time segment list 250 is configured for each physical server 2 by the reservation management part 120 when the reservation management part 120 receives a request for the reservation of a service, in order to compare the reservation terms of other services that overlap the reservation term of the requested service. The time segment list 250 of the physical server 2-1, the time segment list 250 of the physical server 2-2, and the time segment list 250 of the physical server 2-3 are configured in the memory 12.

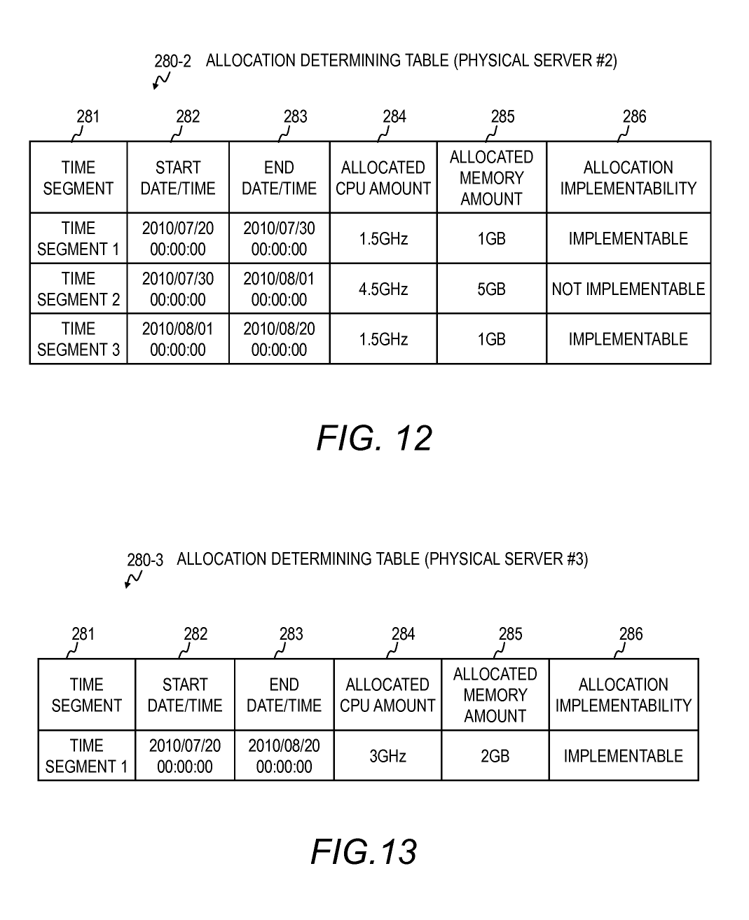

FIGS. 11, 12, and 13 are each a diagram illustrating an example of the allocation determining table 280 which is managed by the reservation management part 120. The allocation determining table 280 is generated for each physical server 2 by the reservation management part 120. FIG. 11 illustrates an allocation determining table 280-1 of the physical server 2-1 (physical server #1), FIG. 12 illustrates an allocation determining table 280-2 of the physical server 2-2 (physical server #2), and FIG. 13 illustrates an allocation determining table 280-3 of the physical server 2-3 (physical server #3). The allocation determining tables 280-1 to 280-3 are collectively referred to as allocation determining tables 280.

On entry of each allocation determining table 280 includes a field for a time segment 281 for storing the identifier of a time segment, a field for a start date/time 282 for storing the start date/time of the time segment, a field for an end date/time 283 for storing the end date/time of the time segment, a field for an allocated CPU amount 284 for storing the allocated amount of the processor 20 that is allocated to the relevant virtual machine 40, a field for an allocated memory amount 285 for storing the allocated amount of the memory 22 that is allocated to the virtual machine 40, and a field for allocation implementability 286 for storing whether the allocation to the virtual machine 40 is implementable or not.

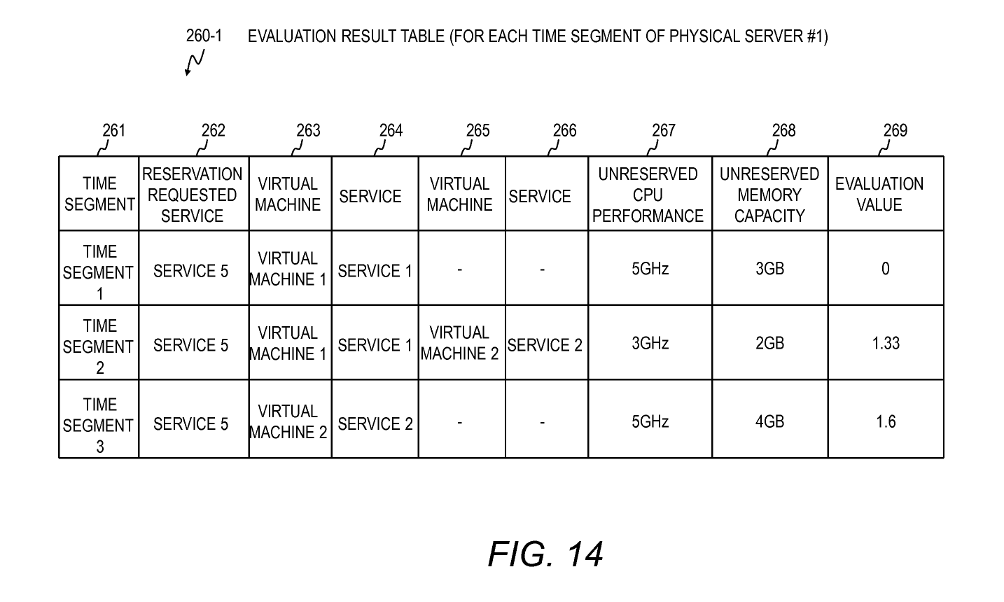

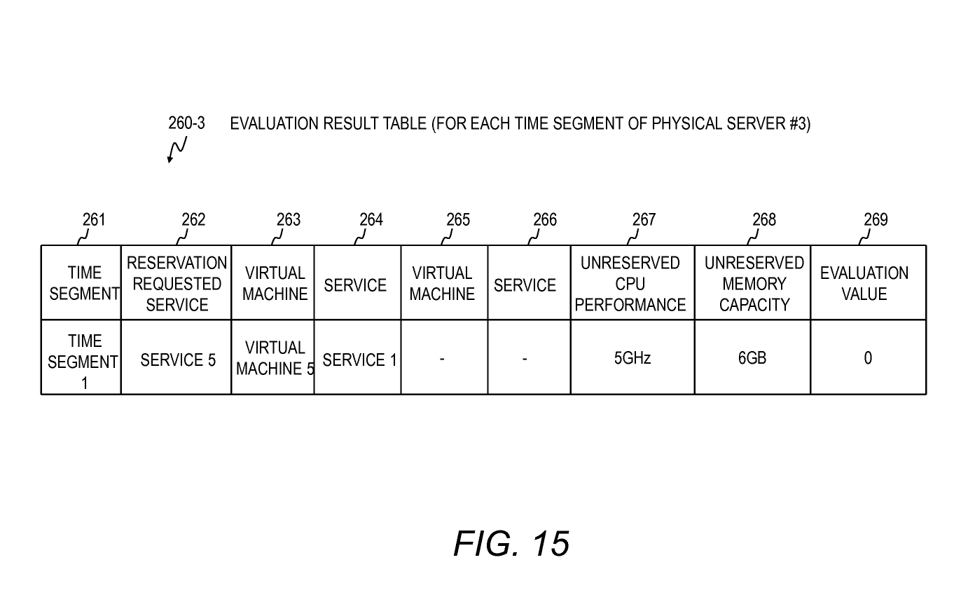

FIGS. 14 and 15 are each a diagram illustrating an example of the evaluation result table 260 which is managed by the reservation management part 120. The evaluation result table 260 is generated for each physical server 2 by the reservation management part 120. FIG. 14 illustrates an evaluation result table 260-1 of the physical server 2-1 (physical server #1), and FIG. 15 illustrates an evaluation result table 260-3 of the physical server 2-3 (physical server #3). The evaluation result tables 260-1 to 260-3 are collectively referred to as evaluation result tables 260.

One entry of each evaluation result table 260 includes a field for a time segment 261 for storing the identifier of a time segment, a field for a reservation requested service 262 for storing the identifier of a service requested to be reserved, fields for services 264 and 266 for storing the identifiers of reserved services, and fields for virtual machines 263 and 265 for storing the identifiers of the virtual machines 40 that execute the reserved services 264 and 266, a field for unreserved CPU performance 267 for storing the amount of resources of the processor 20 that are not reserved for the time segment, a field for an unreserved memory capacity 268 for storing the amount of resources of the memory 22 that are not reserved for the time segment, and a field for an evaluation value 269 which is calculated by the reservation management part 120. The calculation of the evaluation value is described later.

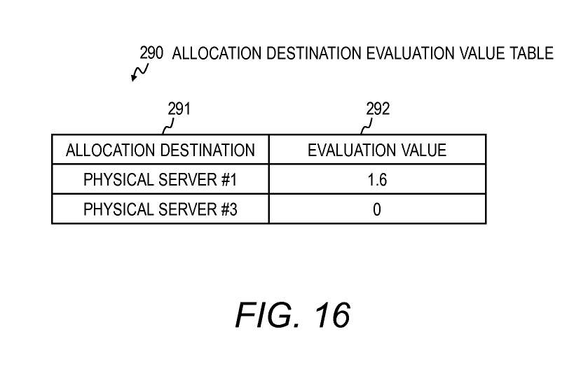

FIG. 16 is a diagram illustrating an example of the allocation destination evaluation value table 290 which is managed by the reservation management part 120. The allocation destination evaluation value table 290 is generated by the reservation management part 120.

One entry of the allocation destination evaluation value table 290 includes a field for an allocation destination 291 for storing the identifier of the physical server 2 to which a service to be reserved is allocated, and a field for an evaluation value 292 which is calculated for each physical server 2 by the reservation management part 120. The calculation of the evaluation value is described later.

<Outline>

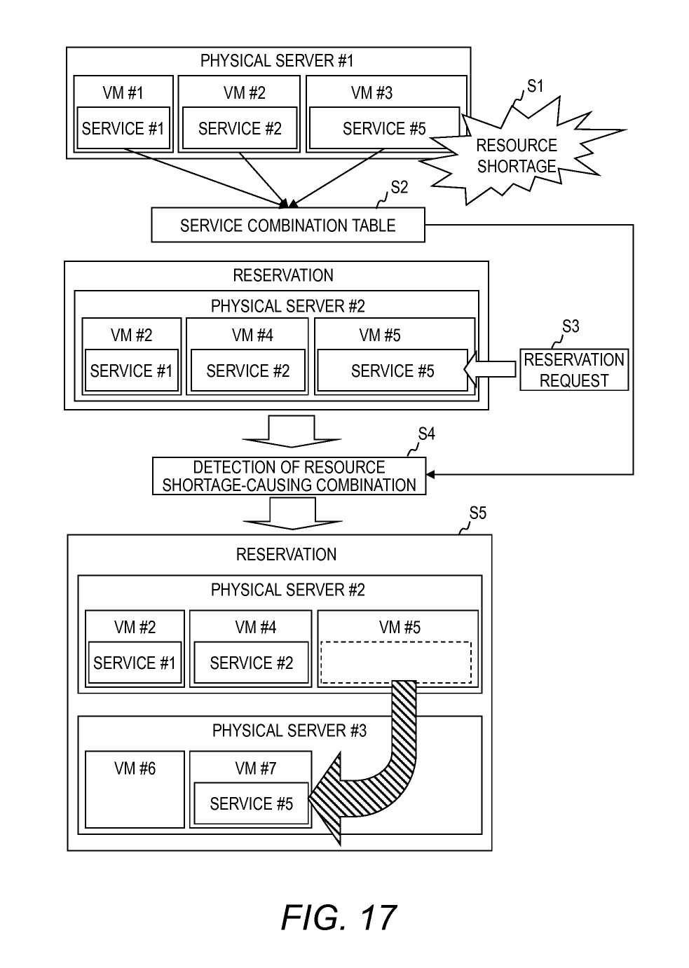

FIG. 17 is a diagram outlining processing of this invention. FIG. 17 illustrates processing that is executed when resources become short in the physical server 2-1 (hereinafter referred to as physical server #1) and then a request to reserve the service #5 is issued from the management client 6.

The management server 1 receives an alert about a shortage of resources or the like from the hypervisor 30 of the physical server #1 (S1), obtains resource information and a combination of services that are being executed from the physical server #1, and adds a new entry to the service combination table 270 as history information that is a record of the time of the alert (S2). In the illustrated example, resources become short when the service #1, the service #2, and the service #5 are executed on the physical server #1. The management server 1 accumulates the combination of services (the service #1, the service #2, and the service #5) and the reserved resource amount that are observed at the time when the hypervisor 30 has sent an alert as resource shortage history information in the service combination table 270.

An example is described in which resources become short in the hypervisor 30 which includes the dynamic logical partitioning part 300. In FIG. 17, the virtual machine #1 executes the service #1, the virtual machine #2 executes the service #2, and the virtual machine #3 executes the service 5 on the physical server #1. When the execution of each service is started first, the hypervisor 30 allocates resources of the physical server #1 to the service in an allocated amount (the allocated CPU amount 244 and the allocated memory amount 245) that is reserved in the reservation table 240. As an example where the hypervisor 30 allocates the memory 22, the virtual machine #1 is allocated 1 GB, the virtual machine #2 is allocated 1 GB, and the virtual machine #3 is allocated 2 GB. The memory capacity 203 of the physical server #1 is “6 GB” referring to the physical server configuration table 200, and the unallocated (and unreserved) memory capacity at this point is therefore 6−(1+1+2)=2 GB.

The load of the service #5 then increases, which increases the load on the virtual machine #3 which executes the service #5 as well. The dynamic logical partitioning part 300 of the hypervisor 30 therefore allocates an unallocated portion of the memory to the virtual machine #3. When the dynamic logical partitioning part 300 additionally allocates unallocated 2 GB out of the memory 22 to the virtual machine #3, the unallocated memory capacity at this point is 6−(1+1+4)=0 GB.

The load of the service #2 then increases, which increases the load on the virtual machine #2 which executes the service #2 as well. The dynamic logical partitioning part 300 of the hypervisor 30 is therefore to allocate an unallocated portion of the memory to the virtual machine #2. However, the physical server #1 currently has no unallocated memory portion. The hypervisor 30 therefore becomes short of resources and outputs an alert. This is an example where resources become short as a result of executing the service #2 and the service #5 on the same physical server, which means that executing the service #1 and the service #2 in combination, or the service #1 and the service #5 in combination, on the same physical server does not cause a shortage of resources.

The management server 1 of this invention therefore accumulates in the service combination table 270 the combination of services being executed at the time when the hypervisor 30 has output an alert. In generating a reservation for allocating the services 42 to the physical servers 2, the management server 1 prevents a future shortage of resources by, when the combination of services to be executed on the same physical server matches a combination in the service combination table 270, shifting the newly reserved services to other physical servers.

The management server 1 receives a request to reserve (the reservation request information 310) of the service #3 from the management client 6 (S3). The reservation management part 120 of the management server 1 obtains the amount of resources required to execute the service #3 and the physical resource situation of each physical server 2 from the reservation table 240, and studies the allocation of the service #5 to the virtual machine (VM#5) of the physical server #2.

The reservation management part 120 searches the service combination table 270 for a service combination that is relevant to reserving the service #5 for the physical server #2. The reservation management part 120 detects a history entry showing that the physical server #1 have become short of resources when the service #1, the service #2, and the service #5 have been executed in combination (S4). The reservation management part 120 excludes the physical server 2 as the allocation destination of the service #5, selects the physical server #3 as a new allocation destination, and reserves the new service #5 for the virtual machine #7 (S5).

Specifically, at the time of reservation, the reservation management part 120 can determine that the physical server #2 has enough resources and has no trouble of executing the service #1, the service #2, and the service #5 simultaneously. From the past resource shortage history of the service combination table 270, however, the reservation management part 120 detects that executing the service #1, the service #2, and the service #5 simultaneously on the physical server #1 has caused a shortage of resources. When detecting a resource shortage history entry, the reservation management part 120 cancels the allocation of the service #5 to the physical server #2, newly selects another physical server that has free resources, namely, the physical server #3, and reserves the new service #5 for the physical server #3.

According to this invention, where combinations of services that have caused a shortage of resources in the past are accumulated in the service combination table 270, the management server 1 is capable of extracting a combination that does not cause a shortage of resources when newly reserving a service, and accomplishes reservation that disposes an appropriate combination of services among physical servers. In addition, with the service combination table 270 recording the allocated resource amount for each service (virtual machine 40) in a combination of services that has caused a shortage of resources, the management server 1 can extract and reserve a combination that does not cause a shortage of resources even more accurately.

<Details of the Processing>

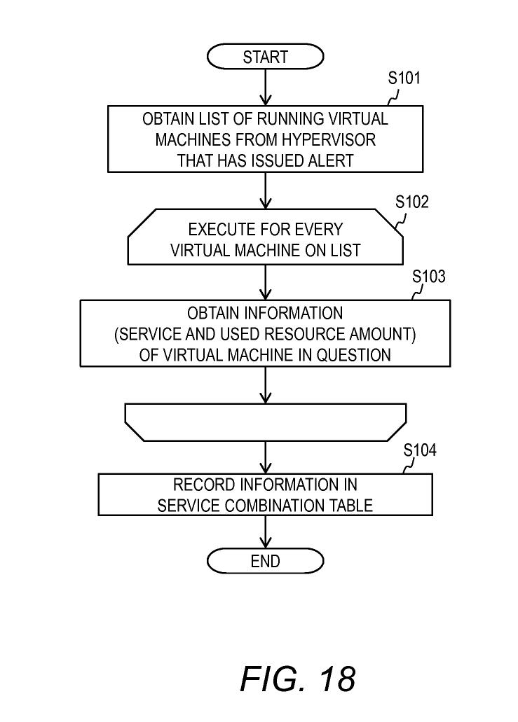

Details of the processing executed in the management server 1 are described below. FIG. 18 is a flow chart illustrating an example of processing that is executed in the resource monitoring part 130 of the management server 1. This processing is resource shortage information obtaining processing which is executed when an alert is received from the hypervisor 30 of one of the physical servers 2.

In Step S101, the resource monitoring part 130 obtains a list (e.g., a list of identifiers) of all the virtual machines 40 that are running under control of the hypervisor 30 that has sent the alert. In Step S102, the resource monitoring part 130 executes Step S103 sequentially for every virtual machine 40 on the obtained list.

In Step S103, the resource monitoring part 130 obtains, from the hypervisor 30, for each virtual machine 40, the service 42 that is executed by the virtual machine 40 and the amount of resources used by the virtual machine 40. When finishing obtaining the information of every virtual machine 40 from the hypervisor 30 where resources have become short, the resource monitoring part 130 adds a new entry to the service combination table 270 (S104).

For example, in the case of adding “resource shortage 3” as the phenomenon 271 to the service combination table 270 as illustrated in FIG. 9, the resource monitoring part 130 adds “service #1 and service #4”, which is the combination of services that have been executed at the time of the resource shortage 3, “physical server #3”, which is the identifier of the relevant physical server 2, and a date and time to the service combination table 270 as the services 273 and 274, the physical server 277, and the date/time 278, respectively.

The resource monitoring part 130 then refers to the reservation table 240 to add up the amount of resources reserved at the time of resource shortage stored as the date/time 278, and to calculate the total amount of resources reserved in the fields for the allocated CPU amount 244 and the allocated memory amount 245 at this date/time. In other words, the resource monitoring part 130 calculates, as a reserved CPU amount and a reserved memory amount each, the total amount of resources to be allocated to the virtual machines 40 that have been executed on the physical server #3 at the date/time 278 (S103).

The resource monitoring part 130 obtains from the physical server configuration table 200 the CPU performance 200 and the memory capacity 203 as the configuration information of the physical server #3 which has become short of resources (resource shortage 3). A value obtained by multiplying the processor core count by the operating frequency (rated frequency) is used as the CPU performance 202.

The resource monitoring part 130 next calculates, as unreserved CPU performance, a value obtained by subtracting from the CPU performance 202 of the physical server #3 the total processor amount reserved for the virtual machines 40 on the physical server #3 which has been obtained in Step S103, and stores the value as the unreserved CPU performance 275.

The resource monitoring part 130 further calculates, as unreserved memory capacity, a value obtained by subtracting from the memory capacity 203 of the physical server #3 the total memory amount reserved for the virtual machines 40 on the physical server #3 which has been obtained in Step S103, and stores the value as the unreserved memory capacity 276.

Through the processing described above, the resource monitoring part 130 adds a history entry about the circumstance of a failure such as a shortage of resources to the service combination table 270 to accumulate the combination of services and the reserved resource amount that are observed at the time when an alert is received from the hypervisor 30.

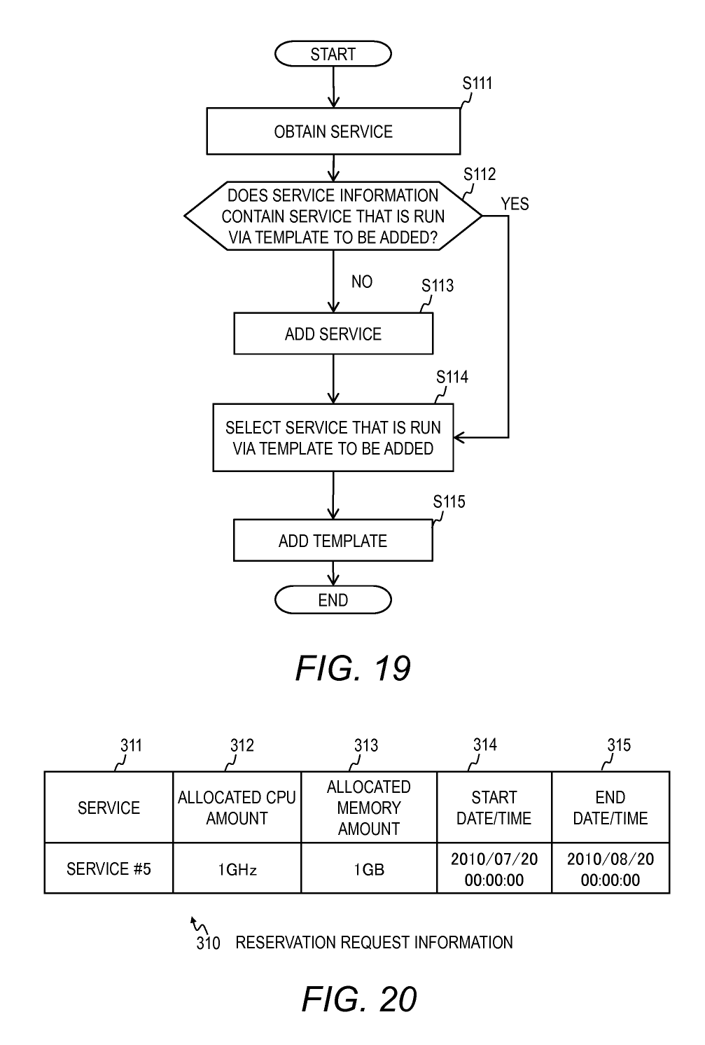

FIG. 19 is a flow chart illustrating an example of processing that is executed by the template management part 110 of the management server 1. This processing is executed by the template management part 110 when a request to register a template is issued from the management client 6.

First, in Step S111, the template management part 110 of the management server 1 receives the identifier of a service to be configured in a template from the management client 6. The management client 6 receives from the input device 63 a service identifier included in the template to be added, and transmits the identifier to the management server 1.

In Step S112, the template management part 110 searches the service list table 220 of FIG. 6 to determine whether or not an identifier that matches the received identifier is found. The processing proceeds to Step S113 in the case where the service list table 220 does not include an identifier that matches the received identifier, and proceeds to Step S114 in the case where an identifier that matches the received identifier is already registered in the service list table 220.

In Step S113, because the received service identifier is that of an unregistered service, the template management part 110 registers the received service identifier in the service list table 220.

In Step S114, the template management part 110 transmits the service list table 220 to the management client 6 to let the management client 6 select a service to be added to the template from the service list. From the management client 6, the template management part 110 receives the allocated CPU amount 233 and the allocated memory amount 234 that are to be allocated when the selected service is executed by one of the virtual machines 40. In the case where the allocated CPU amount 233 and allocated memory amount 234 of the template are not specified by the management client 6, the template management part 110 configures, as the amount of resources applied to the template to be added, the initial values (for example, 1 GHz and 1 GB) of the allocated CPU amount 233 and the allocated memory amount 234 which are configured in advance.

In Step S115, the template management part 110 newly adds to the template list table 230 a combination of the service selected by the management client 6 and the amount of resources allocated to the virtual machine 40 that executes the service. The template management part 110 at this point configures a new identifier for the added template.

FIG. 7 illustrates an example in which the template management part 110 registers a template of the service #6. To register the new “service #6” in a template, the template management part 110 searches the service list table 220, finds out that the value has not been registered, and accordingly add the new “service #6” to the service list table 220. The template management part 110 then receives from the management client 6 the amount of resources used to execute the “service #6” on one of the virtual machines 40 as the allocated CPU amount 233 and the allocated memory amount 234. The template management part 110 gives a template identifier to the combination of the received service identifier and resource amount, and adds the combination plus the template identifier to the template list table 230 as a new entry.

The template list table 230 allows a plurality of templates for one service, and a plurality of resource amount combinations can be configured for the one service in the plurality of templates.

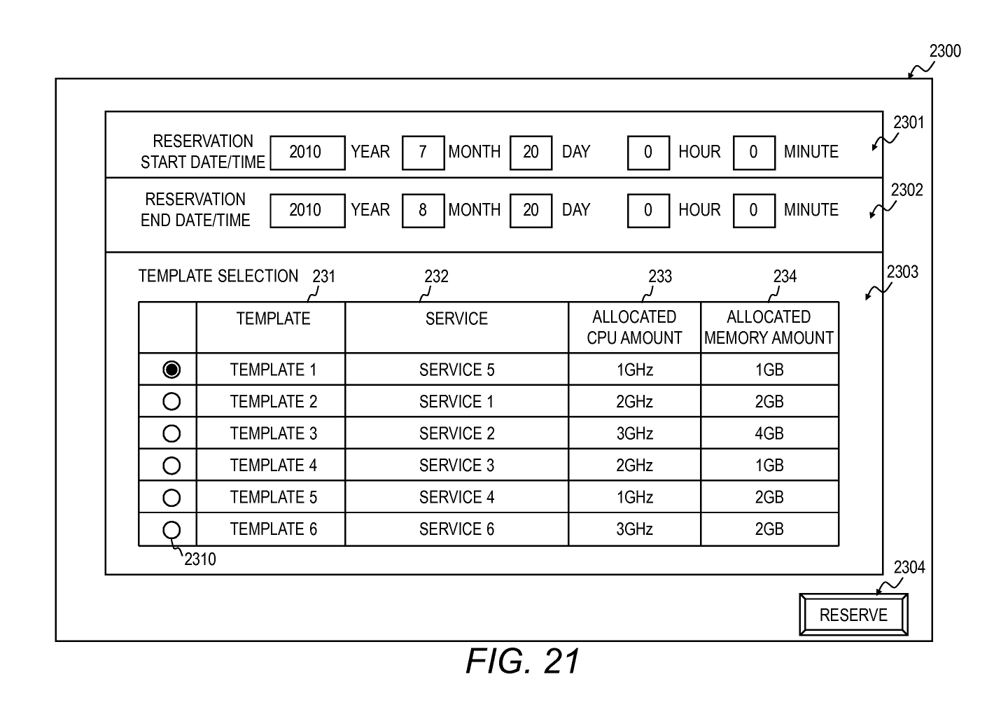

Described next is processing of a reservation received by the management server 1 from the management client 6. A request for a reservation contains, for example, reservation request information illustrated in FIG. 20. The reservation request information 310 of FIG. 20 includes a field for a service 311 for storing the identifier of a service to be reserved, a field for an allocated CPU amount 312 for storing the allocated amount of the processor 20 that is allocated to the virtual machine 40 that executes the service, a field for an allocated memory amount 313 for storing the allocated amount of the memory 22 that is allocated to the virtual machine 40 that executes the service, a field for a date/time 314 at which the service is started, and a field for a date/time 315 at which the service is ended.

In short, the reservation request information 310 can be generated by adding the start date/time 314 and the end date/time 315 to information in the template list table 230 of FIG. 7. The reservation request information 310 can therefore be received with the use of a template selecting screen 2300 illustrated in FIG. 21.

FIG. 21 is a screen image illustrating an example of the template selecting screen 2130 which is provided by the management server 1 to the management client 6 when a reservation is received. When receiving a given reservation request from the management client 6, the management server 1 outputs the template selecting screen 2300 of FIG. 21 to the management client 6.

The template selecting screen 2300 includes a start date/time input area 2301 for entering the start date/time of a service, an end date/time input area 2302 for entering the end date/time of the service, a selection area 2303 where the template list table 230 is displayed in order to let the administrator or the like select a desired service, and a “reserve” button 2304 for issuing an instruction to execute the reservation.

The administrator who uses the management client 6 uses the input device 63 and the output device 64 to enter the start date/time of a service in the start/date time input area 2301, to enter the end date/time of the service in the end date/time input area 2302, and to select a radio button 2310 of a desired template in the selection area 2303. When the administrator using the management client 6 operates the “reserve” button 2304 of the template selecting screen 2300, the reservation management part 120 of the management server 1 starts processing.

When the “reserve” button 2304 is operated, the reservation management part 120 stores the value of the start date/time input area 2301 as the start date/time 314 of the reservation request information 310, stores the value of the end date/time input area 2302 as the end date/time 315 of the reservation request information 310, and stores the service identifier 232, allocated CPU amount 233, and allocated memory amount 234 of the template list table 230 that have been selected with one of the radio buttons 2310 as the service 311, allocated CPU amount 312, and allocated memory amount 313 of the reservation request information 310, respectively. These processing steps may be executed on the management client 6, which then sends the reservation request information 310 to the management server 1.

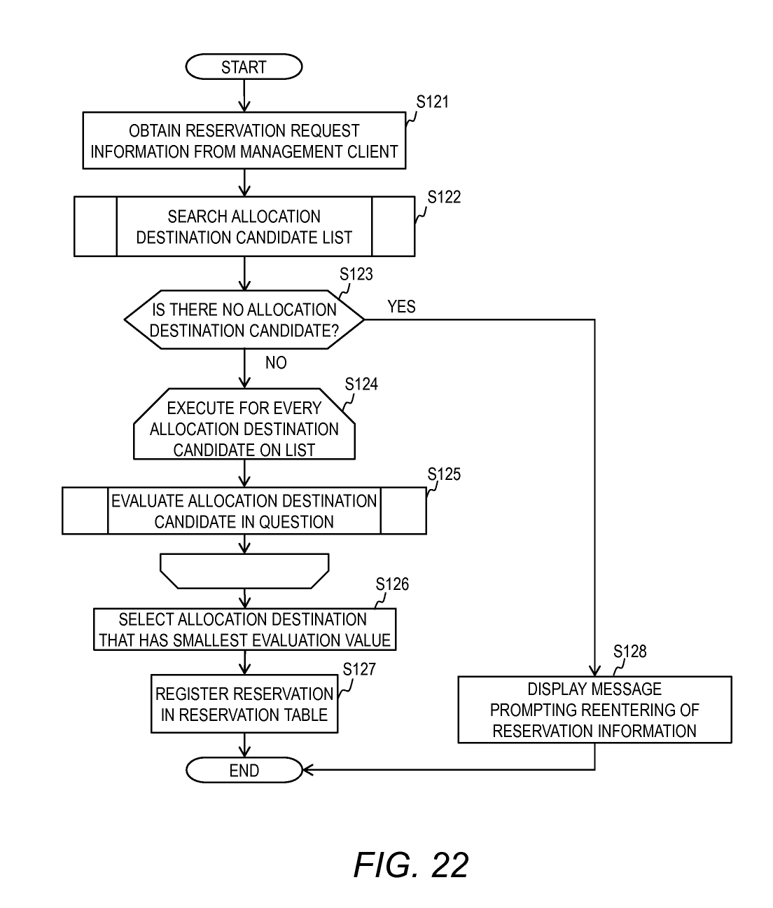

FIG. 22 is a flow chart illustrating an example of reservation processing which is executed in the reservation management part 120 of the management server 1. This processing is executed when reservation request information is received from the management client 6, or when the “reserve” button 2304 of FIG. 21 is operated.

In Step S121, the reservation management part 120 obtains reservation request information from the management client 6.

In Step S122, the reservation management part 120 searches for, as an allocation destination, the physical server 2 that satisfies the amount of resources to be allocated to the virtual machine 40 that executes the service 311 requested by the obtained reservation request information 310. The processing of searching for the allocation destination physical server 2 (allocation destination searching processing) is described later.

In Step S123, the reservation management part 120 determines whether or not the allocation destination physical server 2 has been found in Step S122. The processing proceeds to Step S124 in the case where the reservation management part 120 determines that the allocation destination physical server 2 has been found, and proceeds to Step S128 in the case where the reservation management part 120 determines that the allocation destination physical server 2 has not been found.

In Step S124, the reservation management part 120 executes allocation destination candidate evaluation of Step S125 for every allocation destination candidate physical server 2 found in Step S122. In Step S125, the reservation management part 120 calculates, for each physical server 2 that is an allocation destination candidate, an evaluation value in a manner described later.

In Step S126, the reservation management part 120 selects, as the physical server 2 to which the reservation is allocated, the physical server 2 that has the smallest evaluation value among the evaluation values obtained in Step S125. Here, the reservation management part 120 selects the identifier 291 of the physical server 2 that has the smallest evaluation value 292 in the allocation destination evaluation value table 290.

In Step S127, the reservation management part 120 adds to the reservation table 240 a reservation for executing the received reservation request information 310 on the physical server 2 selected in Step S126, and then ends the reservation processing.

In the case where it is determined in Step S123 that no physical server 2 that is a reservation allocation destination candidate has been found, on the other hand, processing proceeds to Step S128. In Step S128, the reservation management part 120 alerts the management client 6 to the fact that the reservation cannot be made, and outputs a message that suggests reentering the reservation request information 310 or reconsidering the amount of resources.

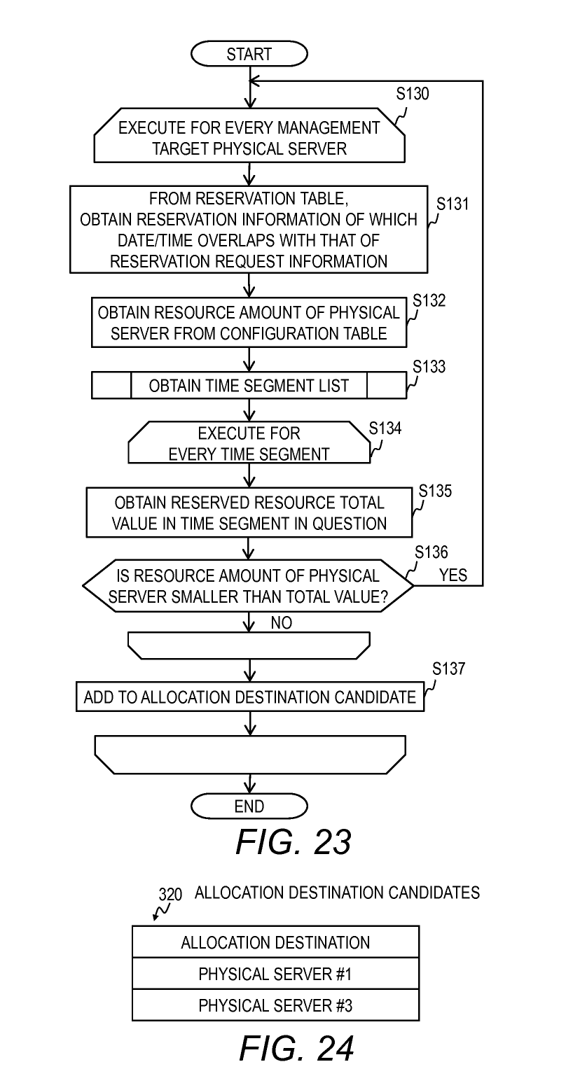

FIG. 23 is a flow chart illustrating an example of the allocation destination candidate searching processing which is executed in Step S122 of FIG. 22 described above.

In Step S130, the reservation management part 120 repeatedly executes Steps S131 to S137 to sequentially process every physical server 2 that is a management target of the management server 1.

In Step S130, the reservation management part 120 selects the physical server 2 that has not been selected from the physical server configuration table 200. In Step S131, the reservation management part 120 searches the reservation table 240 for a reservation of which the date/time overlaps the start date/time 314 and end date/time 315 of the reservation request information 310 obtained in Step S121. This search is conducted with respect to reservation information of the physical server 2 that has been selected in Step S130. The reservation management part 120 obtains, as reservation information of the selected physical server 2 that overlaps, a piece of reservation information in the reservation table 240 whose start date/time 246 coincides or precedes the end date/time 315 of the reservation request information 310 and whose end date/time 247 is concurrent with or later than the start date/time 314 of the reservation request information 310.

In Step S132, the CPU performance 202 and the memory capacity 203 are obtained from the physical server configuration table 200 as the amount of resources of the physical server 2 selected in Step S130.

In Step S133, the reservation management part 120 divides a reservation request time segment from the start date/time 314 to end date/time 315 of the reservation request information 310 into a plurality of time segments based on the overlapping reservation information obtained in Step S131, and obtains a list of the plurality of time segments as the time segment list 250 of FIG. 10 in a manner described later. The time segment list 250 is generated by processing that configures a time segment for each time point at which the virtual machine 40 (a service) that is already reserved is started or ended, between the start point (start date/time 314) of the reservation request time segment and the end point (end date/time 315) of the reservation request time segment, beginning from the start point and moving toward the end point. This embodiment describes an example in which one service is executed on one virtual machine 40.

In Step S134, Steps S135 and S136 are repeated to sequentially process every time segment on the time segment list 250 obtained in Step S133.

In Step S135, the reservation management part 120 selects one time segment that has not been selected from the time segment list 250, and calculates the sum of the reserved amount of resources of the physical server 2 in question that are reserved for the reservation table 240 in this time segment and the resource amount of the reservation request information 310. In the example of this embodiment where the CPU performance and the memory capacity are used as the amount of resources, the reservation management part 120 separately calculates the total reserved amount of the CPU performance that is reserved for the selected time segment and the total reserved amount of the memory capacity that is reserved for the selected time segment. In short, the reservation management part 120 calculates, for each resource type, the total amount of resources reserved for the selected time segment.

In Step S136, the reservation management part 120 determines whether or not the amount of resources of the currently selected physical server 2 is smaller than the total reserved amounts calculated in Step S135. Specifically, in the case where a value obtained by adding the resource amount of the reservation request information 310 to the amount of already reserved resources exceeds the amount of resources of the currently selected physical server 2, the physical server 2 is not suitable as the allocation destination and is therefore excluded. In the example of this embodiment, the reservation management part 120 determines the currently selected physical server 2 as unsuitable as the allocation destination in the case where the CPU performance 202 of the physical server 2 is smaller than the total reserved CPU amount, or the memory capacity 203 of the physical server 2 is smaller than the total reserved memory amount, in the current time segment. On the other hand, the reservation management part 120 determines the selected physical server 2 as suitable as the allocation destination in the case where the CPU performance 202 of the physical server 2 is equal to or larger than the total reserved CPU amount and the memory capacity 203 of the physical server 2 is equal to or larger than the total reserved memory amount in the current time segment.

In the case where the reservation management part 120 determines the currently selected physical server 2 as unsuitable as the allocation destination, the physical server 2 cannot process the service requested to be reserved continuously throughout the reservation request time segment, and is therefore excluded from among allocation destination candidates. The processing then returns to Step S130 to repeat the processing described above for the next unprocessed physical server 2.

In the case where repeating Steps S134 to S136 reveals that the amount of resources of the currently selected physical server 2 satisfies the reservation request information 310 throughout the entire reservation request time segment, the reservation management part 120 configures the identifier of the physical server 2 in question as an allocation destination candidate in Step S137.

By executing the processing described above repeatedly until every physical server 2 is processed, a list of the physical servers 2 of which the amounts of resources satisfy the reservation request information 310 throughout the entire reservation request time segment can be configured as allocation destination candidates. Allocation destination candidates 320, which may be a table storing the identifiers of the physical servers 2 as illustrated in FIG. 24 or may be a variable, are stored in the memory 22. The allocation destination candidates 320 hold a list of the physical servers 2 that satisfy the resource amount of the reservation request information 310.

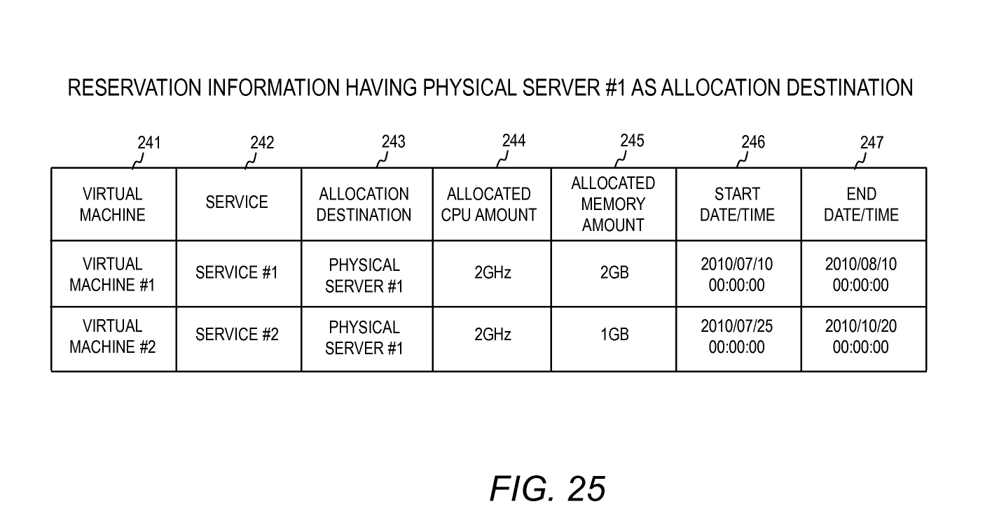

FIG. 25 illustrates a reservation situation where the physical server 2 for which a time segment reserved in the reservation table 240 (reserved time segment) overlaps the reservation request time segment has an identifier “#1”. As a result of the processing of FIG. 23, the reservation management part 120 can obtain, for each physical server 2, the virtual machine 40 for which a reserved time segment in the reservation table 240 overlaps the reservation request time segment.

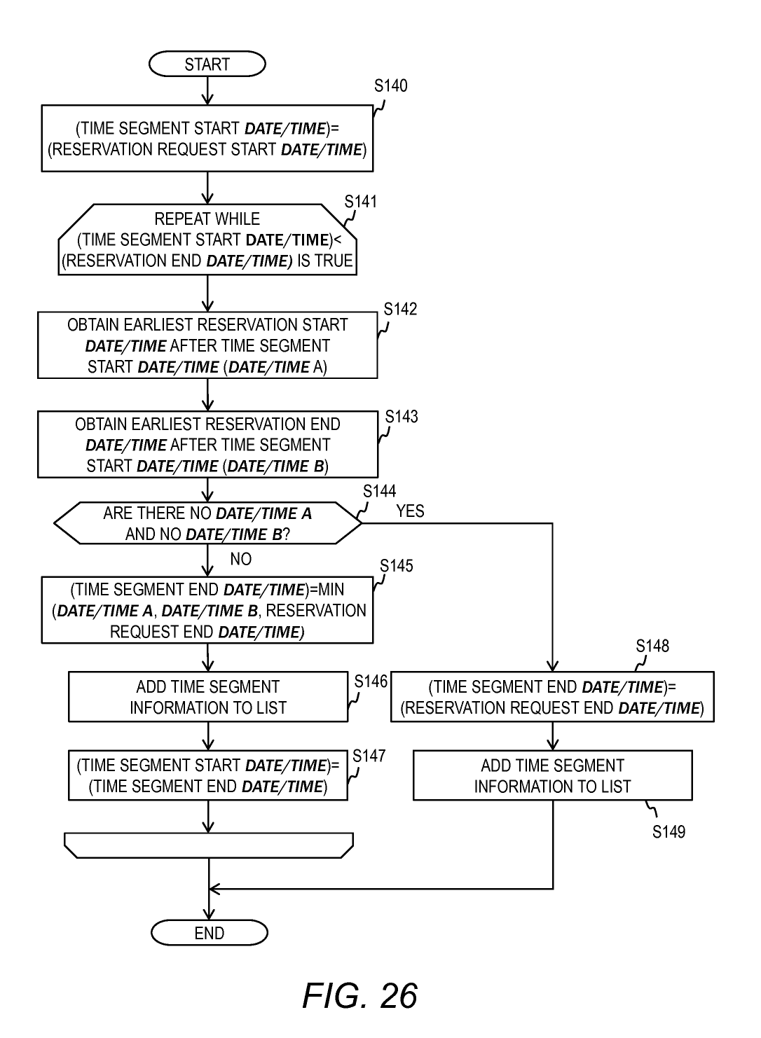

FIG. 26 is a flow chart illustrating an example of the processing of obtaining the time segment list 250 which is executed in Step S133 of the allocation destination candidate searching processing of FIG. 23.

The reservation management part 120 configures, as a time segment start date/time, the start date/time 314 of the reservation request information 310 obtained in Step S121 of FIG. 22. The reservation management part 120 repeats Steps S141 to S147 until the time segment start date/time reaches the end date/time 315 of the reservation request information 310 (the reservation end date/time).

In Step S142, the reservation management part 120 searches the reservation table 240 for the reservation start date/time 246 that is concurrent with or later than the time segment start date/time and that is the earliest (closest) among pieces of reservation information of the currently selected physical server 2. The reservation management part 120 configures the obtained reservation start date/time 246 as a variable: date/time A.

In Step S143, the reservation management part 120 searches the reservation table 240 for the reservation end date/time 247 that is concurrent with or later than the time segment start date/time and that is the earliest (closest) among pieces of reservation information of the currently selected physical server 2. The reservation management part 120 configures the obtained reservation end date/time 247 as a variable: date/time B.

In Step S144, the reservation management part 120 determines whether neither date/time A nor date/time B is found in the table. In the case where neither date/time A nor date/time B is found (no value is found), the processing proceeds to Step S148 and the reservation management part 120 ends the loop of Steps S141 to S147.

In Step S148, the reservation management part 120 configures the end date/time 315 of the reservation request information 310 as the time segment end date/time. In Step S149, the reservation management part 120 then adds a time segment identifier to the time segment start date/time configured in Step S140 and the time segment end date/time of Step S148, and adds this to the time segment list 250 of the current physical server 2.

In the case where it is determined in Step S144 that at least one of date/time A and date/time B is found in the table, on the other hand, it means that the reservation request time segment overlaps a plurality of reserved time segments. The processing therefore proceeds to Step S145.

In Step S145, the time segment end date/time is configured by the following expression:

(Time segment end date/time)=MIN(date/time A,date/time B,reservation request end date/time) (1)

where MIN is a function for selecting the smallest value of date/time A, date/time B, and the reservation request end date/time.

In Step S146, the reservation management part 120 adds a time segment identifier to the time segment start date/time configured in Step S140 and the time segment end date/time obtained in Step S145, and adds this to the time segment list 250 of the current physical server 2.

In Step S147, the reservation management part 120 configures the current time segment end date/time as the time segment start date/time, and the processing returns to Step S142 to obtain the next time segment.

Through the processing described above, the reservation request time segment from the start date/time 314 to end date/time 315 of the reservation request information 310 is divided into one or a plurality of terms to generate the time segment list 250 for each physical server 2. The time segment list 250 is a list in which the reservation request time segment is divided by a date/time that overlaps a reserved time segment in the reservation table 240 and that is the start or end of a reserved time segment.

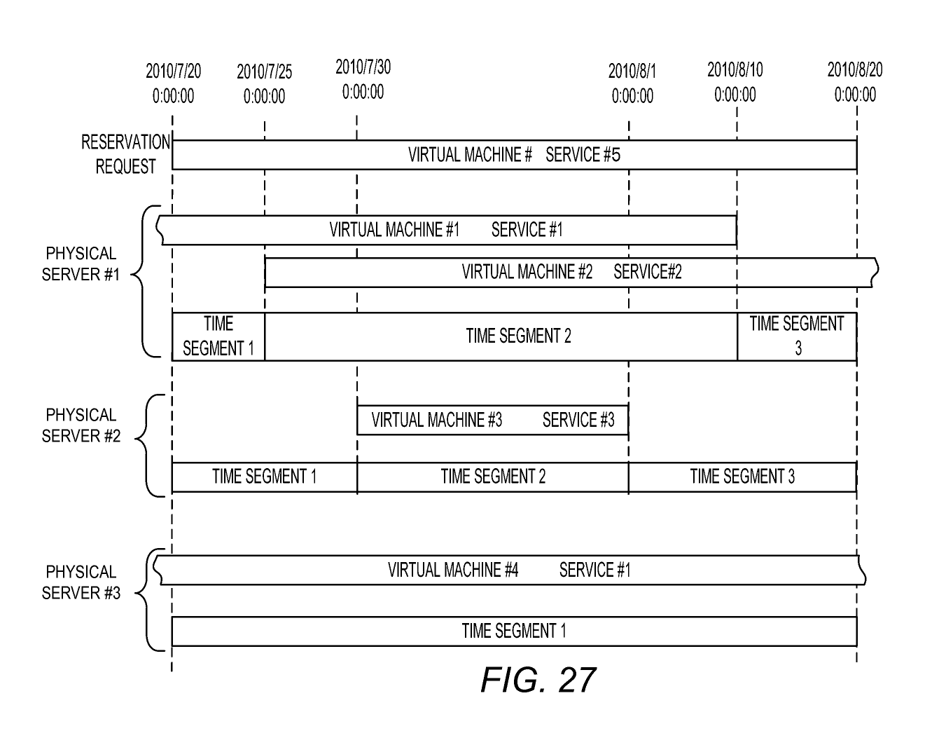

FIG. 27 illustrates time segment lists of the reservation request time segment of the respective physical servers 2. As illustrated in FIG. 10, the reservation request time segment of the reservation request information 310 is divided into three time segments, a time segment 1 to a time segment 3, in the physical server #1 by reserved time segments. Specifically, in the processing of FIG. 26, a reserved start date/time and a reserved end date/time are searched for in the reservation request time segment after the start date/time of the time segment list is configured as the start date/time of the reservation request time segment of FIG. 27.

In FIG. 27, services that overlap the reservation request time segment in reserved time segments of the physical server #1 are the service #1 of the virtual machine #1 and the service #2 of the virtual machine #2. The start date/time of the service #1 of the virtual machine #1 is closer to the start point than the end date/time of the service #2 is, and a time segment in the reservation request time segment that is from the start point to the start date/time of the service #2 therefore constitutes the time segment 1. The time segment 2 is from the start date/time of the service #2 to the end time/date of the service #1, and the time segment 3 is from the end date/time of the service #1 to the end date/time of the reservation request time segment.

In the physical server #3, on the other hand, the service #1 of the virtual machine #4 does not start and end within the reservation request time segment, and the entire reservation request time segment constitutes one time segment 1.

Time segments of the reservation request time segment thus vary in the time segment list 250 from one physical server 2 to another, depending on the situation of reserved time segments of the physical server 2.

The reservation management part 120 can generate, in addition to the time segment list 250 described above, the allocation determining tables 280-1 to 280-3 illustrated in FIG. 11, FIG. 12, and FIG. 13. In the allocation determining table 280-2 of the physical server #2 of FIG. 12, the allocation implementability 286 is “not implementable” in the time segment 2 and, accordingly, entries may not be created for time segments that follow the time segment 2. In other words, the physical server 2 that includes a time segment in which the allocation implementability 286 is “not implementable” is excluded from the allocation destination candidates 320 because the aim is to process the service of the reservation request information 310 continuously on one physical server 2.

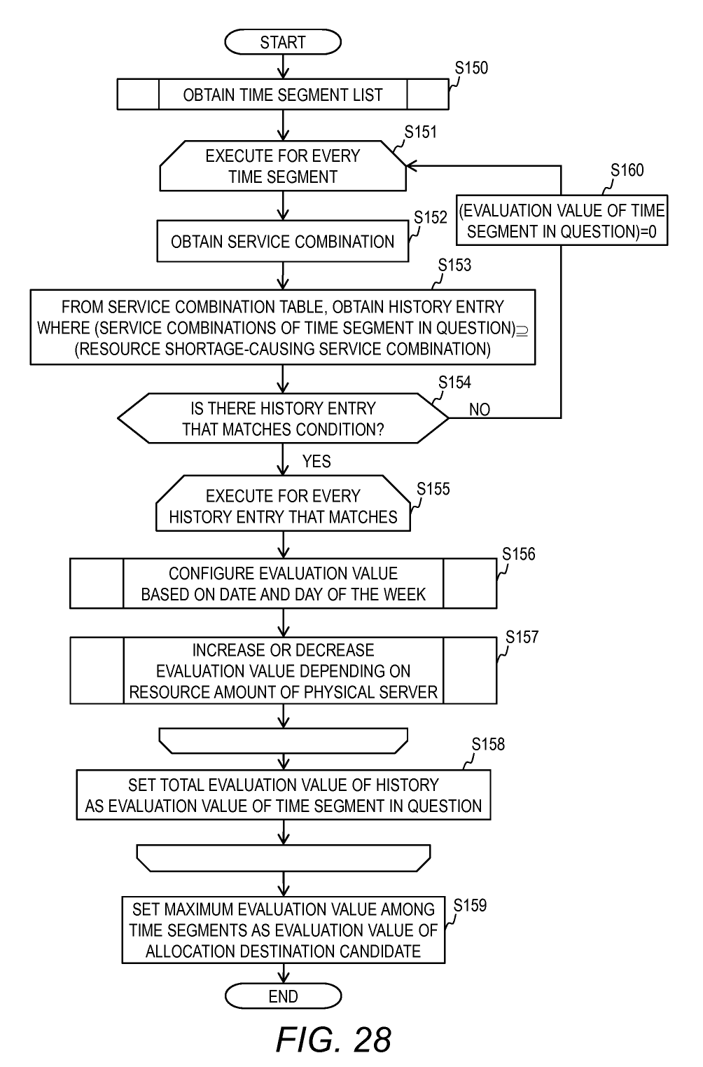

FIG. 28 is a flow chart illustrating an example of the allocation destination candidate evaluating processing which is executed in Step S125 of FIG. 22. This processing is executed after the allocation destination candidate list (allocation destination candidates 320) and the time segment list 250 are obtained in processing of FIG. 22.

In Step S150, the reservation management part 120 obtains the time segment list 250. The reservation management part 120 repeats Steps S151 to S157 until every time segment on the time segment list 250 is processed. In Step S151, the reservation management part 120 selects one time segment that has not been selected from the time segment list 250. At this point, the reservation management part 120 obtains the identifier of the physical server 2 that is relevant to the selected time segment as well.

In Step S152, the reservation management part 120 searches the reservation table 240 for the identifier of the physical server 2 with the use of the start date/time 252 and end date/time 253 of the currently selected time segment, and obtains the combination of services that have been reserved for the time segment. The reservation management part 120 then generates a search-use service combination by adding the service 311 of the reservation request information 310 to the obtained combination of reserved services.

In Step S153, the reservation management part 120 searches the service combination table 270 for a combination that includes the search-use service combination generated in Step S152. In Step S154, the reservation management part 120 determines whether or not an entry that includes the search-use service combination is found in the service combination table 270. In the case where there is no entry that includes the search-use service combination, the reservation management part 120 sets the evaluation value of the current time segment to “0” and then returns to Step S151 to repeat the processing described above.

In the case where an entry that includes the search-use service combination is found in the service combination table 270, on the other hand, the reservation management part 120 proceeds to Step S155. The reservation management part 120 at this point detects a history entry showing that the search-use service combination, specifically, the combination of a new service requested to be reserved and already reserved services has caused an anomaly such as a shortage of resources in the past. The reservation management part 120 may output an alert to the management client 6 regarding the fact that the combination of the service requested to be reserved (the reservation request information 310) and already reserved services has caused a trouble (an anomaly in physical computer) in the past. In other words, the management server 1 is capable of alerting the management client 6 to the fact that the combination of the just received service and already reserved services is, although does not use resources in an amount that exceeds the amount of resources of the relevant physical server 2 when the service is allocated first, likely to cause a shortage of resources in the physical server 2 eventually as the simultaneous execution of the just received service and the already reserved services is continued.

In other words, in this embodiment, a history entry that includes a combination of services already reserved for the currently selected time segment and the service #5 requested to be reserved (the search-use service combination) is evaluated in the case where there is a history entry showing that executing this combination on the currently selected physical server 2 (#1) has caused a shortage of resources.

In Step S155, the reservation management part 120 selects one entry that has not been selected from among resource shortage history entries of the service combination table 270 that satisfies the condition of Step S153. In Step S156, the reservation management part 120 calculates an evaluation value for the resource shortage history entry selected from the service combination table 270, based on the date and the day of the week, or other periods of time.

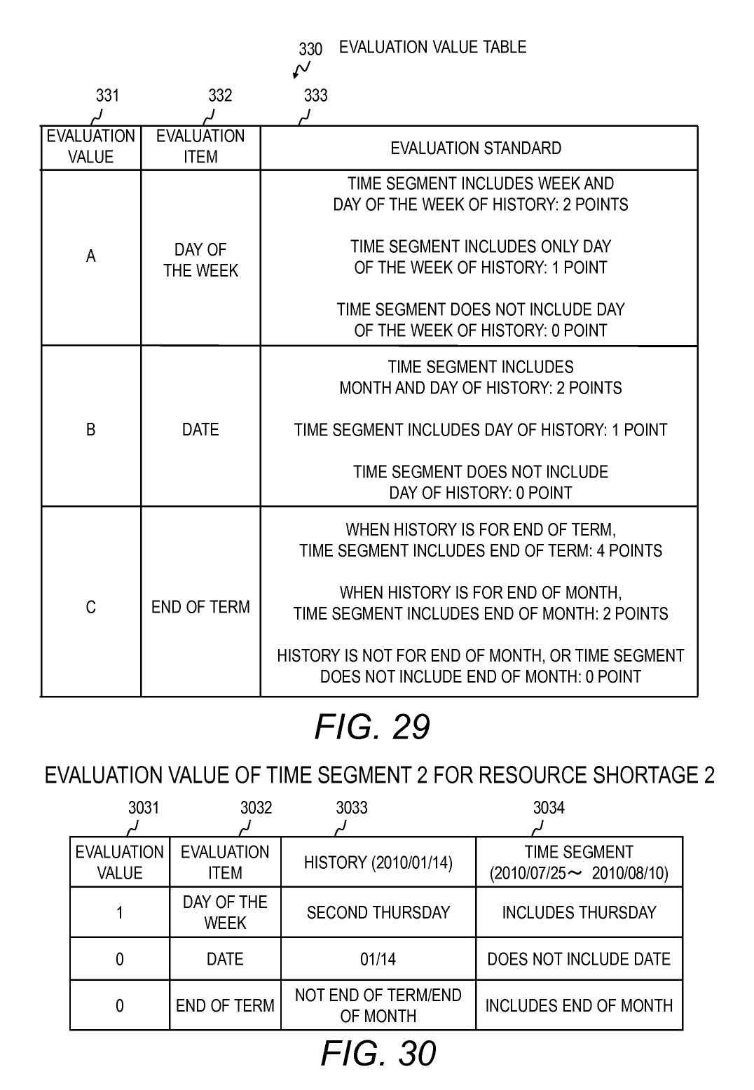

With the use of an evaluation value table 330 of FIG. 26, the reservation management part 120 calculates an evaluation value based on the day of the week and date, or other periods of time, of the selected resource shortage entry. FIG. 29 illustrates an example of the evaluation value table 330. One entry of the evaluation value table 330 includes a field for an evaluation value 331 which indicates a variable of the evaluation value, a field for an evaluation item 332 which indicates an item to be evaluated, and a field for an evaluation standard 333 for storing details of how an evaluation value is given.

As a variable A, a value graded by the evaluation standard 333 that has “the day of the week” as the evaluation item 332 is configured.

According to the evaluation standard 333 that has “the day of the week” as the evaluation item 332, the variable A is 2 points in the case where the currently selected time segment includes the same week and the same day of the week as the date/time 278 of resource shortage in the currently selected history entry.

According to the evaluation standard 333 that has “the day of the week” as the evaluation item 332, the variable A is 1 point in the case where the currently selected time segment includes only the same day of the week as the date/time 278 of the currently selected resource shortage history entry.

According to the evaluation standard 333 that has “the day of the week” as the evaluation item 332, the variable A is 0 points in the case where the currently selected time segment does not include the same day of the week as the date/time 278 of the currently selected resource shortage history entry.

As a variable B, a value graded by the evaluation standard 333 that has “the date” as the evaluation item 332 is configured.

According to the evaluation standard 333 that has “the date” as the evaluation item 332, the variable B is 2 points in the case where the currently selected time segment includes the same month and the same day as the date/time 278 of the currently selected resource shortage history entry.

According to the evaluation standard 333 that has “the day of the week” as the evaluation item 332, the variable B is 1 point in the case where the currently selected time segment includes only the same day as the date/time 278 of the currently selected resource shortage history entry.

According to the evaluation standard 333 that has “the day of the week” as the evaluation item 332, the variable B is 0 points in the case where the currently selected time segment does not include the same day as the date/time 278 of the currently selected resource shortage history entry.

As a variable C, a value graded by the evaluation standard 333 that has “the end of term” as the evaluation item 332 is configured.

According to the evaluation standard 333 that has “the end of term” as the evaluation item 332, the variable C is 4 points in the case where the date/time 278 of the currently selected resource shortage history entry is the end of term and the currently selected time segment is the end of term.

According to the evaluation standard 333 that has “the day of the week” as the evaluation item 332, the variable C is 2 points in the case where the date/time 278 of the currently selected resource shortage history entry is the end of month and the currently selected time segment is the end of term.

According to the evaluation standard 333 that has “the day of the week” as the evaluation item 332, the variable C is 0 points in the case where the date/time 278 of the currently selected resource shortage history entry is not the end of month and the currently selected time segment is not the end of month.

The reservation management part 120 uses the evaluation value table 330 to separately calculate the variables A, B, and C from the currently selected time segment and the date/time 278 of the resource shortage history entry. The reservation management part 120 then calculates an evaluation value by the following expression:

(Evaluation value)=1+A+B+C (2)

In Step S157, the evaluation value is corrected based on the amount of resources of the physical server 2 that are associated with the currently selected time segment. The reservation management part 120 obtains the amount of resources of the physical server 2 that are associated with the currently selected time segment from the physical server configuration table 200 to calculate the following variables R1 and R2.

R/=(unreserved CPU performance of the history)/(unreserved CPU performance of the physical server) (3)

The unreserved CPU performance of the history is the unreserved CPU performance 275 of the service combination table 270, and the unreserved CPU performance of the physical server is the unreserved CPU performance 267 of the evaluation result table 260 of FIGS. 14 and 15. The CPU performance is expressed as clock count×core count as described above.

R2=(unreserved memory capacity of the history)/(unreserved memory capacity of the physical server) (4)

The unreserved memory capacity of the history is the unreserved memory capacity 276 of the service combination table 270, and the unreserved memory capacity of the physical server is the unreserved memory capacity 268 of the evaluation result table 260 of FIGS. 14 and 15. The CPU performance is expressed as clock count×core count as described above.

The reservation management part 120 configures, as a variable E, an evaluation value based on the date and the day of the week which is calculated by the Expression (2).

E=1+A+B+C (5)

The reservation management part 120 uses the variables R1, R2, and E to update the evaluation value as follows:

(Evaluation value)=E×max(R1,R2) (6)

where max(R1, R2) is a function for selecting the larger value of R1 and R2.

For example, in the case of reserving the service #5 of the reservation request information 310 of FIG. 20 for the physical server #1, the combination of the service #2 and the service #5 in the time segment 2 in FIG. 27 corresponds to a resource shortage 2 in the service combination table 270 of FIG. 9, and the evaluation value is therefore calculated.

The reservation management part 120 first uses the evaluation value table 330 to obtain evaluation values with respect to the date, the day of the week, and the end of term in Step S156. The variables A to C are calculated as illustrated in FIG. 29 for the evaluation values with respect to the date, the day of the week, and the end of term from the time segment 2 of the physical service #1 and the value of the resource shortage 2 of the service combination table 270. In FIG. 30, an evaluation value 3031 corresponds to the variables of the evaluation value 331 of the evaluation value table 330 in FIG. 29, an evaluation item 3032 corresponds to the evaluation item 332 of the evaluation value table 330 in FIG. 29, a history 3033 indicates information about the month and day of the resource shortage 2, and a time segment 3034 indicates information about the month and day of the time segment 2.

As a result, Expression (5) is calculated as:

E=1+1+0+0=2

Expression (3) is calculated as:

R1=2/{2×4−(2+2+1)}=2/3

Expression (4) is calculated as:

R2=1/{6−(2+1+1)}=1/2

Consequently, the evaluation value is calculated by Expression (6) as follows:

(Evaluation value)=2×max(2/3,1/2)=4/3≈1.33

In Step S157, this evaluation value is stored in the evaluation result table 260 of the currently selected time segment.

After the processing described above is finished for every resource shortage history entry that matches the service combination of the currently selected time segment, the reservation management part 120 executes Step S158.

In Step S158, the reservation management part 120 calculates, as the evaluation value of the currently selected time segment, the sum of the evaluation values calculated for the time segment in Step S157. The physical server #1 in the example given above has 0 as the evaluation value of the time segment 1, approximately 1.33 as the evaluation value of the time segment 2, and 1.6 as the evaluation value of the time segment 3. The reservation management part 120 stores an evaluation value for each time segment in the evaluation result table 260.

After Steps S151 to S158 are finished for every time segment, the reservation management part 120 proceeds to Step S159. In Step S159, the reservation management part 120 configures, for each physical server 2, the highest evaluation value among the evaluation values of the respective time segments in the allocation destination evaluation value table 290 as the evaluation value of the physical server 2. For instance, when the identifiers of the physical servers 2 that are included in the allocation destination candidates 320 are “physical server #1” and “physical server #3”, the evaluation value 1.6 of the physical server #1 and the evaluation value 0 of the physical server #3 are stored as the evaluation value 292 as illustrated in FIGS. 14 and 15.

After the processing of FIG. 28 is ended, the reservation management part 120 proceeds to Step S126 of FIG. 22 described above to select the identifier 291 of the physical server 2 that has the smallest evaluation value 292 in the allocation destination evaluation value table 290 as the allocation destination of the reservation request information 310, and registers the identifier in the reservation table 240.

As has been described, according to this embodiment where the combination of services that has caused an anomaly such as a shortage of resources in the past is stored in the service combination table 270 along with the relevant physical server 2, the management server 1 can avoid a combination of services that has a chance of causing an anomaly such as a shortage of resources when additionally reserving a new service. The management server 1 in a virtual computer system in which a service is provided by each of a plurality of virtual machines executed on the physical servers 2 can thus appropriately dispose the virtual machines and the services among the physical servers 2, and optimum reservation is accomplished. Specifically, there are cases where, although a shortage of resources is not caused at the time the execution of a combination of reserved services is started, the load of the services increases with the progress of the running term and the virtualizing part (the hypervisor 30) allocates more resources to the virtual machines 40 that execute the services. If the virtualizing part keeps increasing the amount of resources allocated to the plurality of services on the relevant physical server 2, the virtualizing part may become short of resources to allocate. The management server 1 therefore issues an alert about or avoids a combination of services that causes an anomaly such as a shortage of resources of the physical server 2 in long term, based on the history of the past anomaly.

The management server 1 also keeps track of the amounts of resources reserved for the respective services at the time of an anomaly such as a shortage of resources, and can therefore extract, and reserve in the reservation table 240, a combination that does not cause a shortage of resources even more accurately.

The service combination table 270 further stores, as processing characteristics of the respective services, the day of the week, the hour of the day, or other periods of time when resources have become short. The management server 1 can therefore extract and reserve a combination that does not cause a shortage of resources by taking into account the period of time for newly reserving a service, including the hour of the day and the day of the week, as well. Specifically, some services increase in load and the amount of resources used on weekends or a particular day, or in a particular period of time such as the end of month or the end of term, with the result that the hypervisor 30 becomes short of resources. The management server 1 can predict a combination of services that causes, although the amount of resources to be reserved for the services plus the amount of resources for already reserved services is equal to or less than the amount of resources of the physical server 2 that executes the relevant virtual machines 40 at the time the services are reserved, a shortage of resources when the given period of time arrives.

With the service combination table 270 storing a combination of services that has caused an anomaly such as a shortage of resources in the past and the relevant physical server 2, the management server 1 can notify the management client 6 of a combination that causes a shortage of resources when a new service is additionally reserved. An inappropriate combination of services can thus be notified to the administrator who uses the management client 6, or others.

The management server 1 of this embodiment also stores in the template list table 230 a template in which a service and a required amount of resources are set in advance. The administrator, a user, or the like who wishes to reserve a service only needs to select a template and enter the start and end date/time of the reservation, without contemplating the required amount of resources. This eliminates the need to configure a required resource amount for each reservation, and greatly saves the administrator, a user, or the like the work that is involved in making a reservation.

While the embodiment described above deals with an example in which the hypervisor 30 runs the virtual machines 40, the virtualizing part for allocating resources of the relevant physical server 2 to the virtual machines 40 can instead be a Virtual Machine Monitor (VMM).

In the embodiment described above, the resource monitoring part 130 records a combination of services and a resource state in the service combination table 270 when a resource shortage notification is received from the hypervisor 30. However, information stored in the service combination table 270 is not limited to one about a shortage of resources. For instance, the management server 1 is notified when one of the virtual machines 40 notifies the hypervisor 30 of an anomaly, or when the hypervisor 30 detects the shutdown of one of the virtual machines 40. The management server 1 receives the notification of anomaly from the hypervisor 30, and adds an entry to the service combination table 270 by configuring the phenomenon 271 in a manner suited to the type of the anomaly.

The embodiment described above deals with an example in which the management server 1 is built from a physical computer. Alternatively, the management server 1 may be provided by one of the virtual machines 40. In this case, one of the virtual machines 40 functions as a management part to manage service reservation and computer resources.

The embodiment described above deals with an example in which the management server 1 detects a combination of services that causes an anomaly such as a shortage of resources, and accumulates the combination in the service combination table 270. Alternatively, the resource monitoring part 130 of FIG. 2 may be removed so that the service combination table 270 that is configured in advance is used. The service combination table 270 in this case records, in advance, a combination of services that has a chance of causing an anomaly such as a shortage of resources in one of the physical servers 2, and a period of time in which the anomaly is likely to occur.

This invention is applicable to a virtual computer system in which a service is provided by a virtual machine and the execution of a service is reserved. This invention is particularly applicable to a management computer for managing a physical computer to which a plurality of virtual machines are allocated.

What is claimed is:

1. A service reservation management method for a plurality of physical computers, each of which comprises a processor and a memory, at least one virtual machine, which is provided by a virtualizing part executed on each of the plurality of physical computers, and a management computer for managing a service allocated to the at least one virtual machine and the virtualizing part, the method comprising:
a first step of receiving, by the management computer, a reservation of a service;
a second step of searching, by the management computer, for a combination of the received service and a service of reservation information in which a service that has been already reserved is stored, by referring to service combination information for storing a combination of services that has a chance of causing an anomaly in one of the plurality of physical computers; and
a third step of outputting, by the management computer, when the service combination information comprises the combination of the received service and the service stored in the reservation information, an alert indicating that the combination has a chance of causing an anomaly.

2. The service reservation management method according to claim 1,
wherein the service combination information stores a combination of services that has a chance of causing an anomaly when executed simultaneously on one of the plurality of physical computers,
wherein, in the first step, the management computer receives the service and a running term of the service as a reservation request term,
wherein the second step comprises:
extracting, by the management computer, a service whose running term comprised in the reservation information overlaps the reservation request term; and
searching, by the management computer, the service combination information for a combination of the extracted service and the service for which the reservation has been received, and
wherein, in the third step, when the service combination information comprises the combination of the extracted service and the service for which the reservation has been received, the management computer outputs an alert indicating that the combination of the extracted services and the service for which the reservation has been received has a chance of causing an anomaly when executed simultaneously on one of the plurality of physical computers.

3. The service reservation management method according to claim 2,
wherein the first step further comprises receiving, by the management computer, an amount of physical computer resources to be allocated to a first virtual machine for running the service for which the reservation has been received, and
wherein the second step comprises:
extracting, by the management computer, a service whose running term comprised in the reservation information overlaps the reservation request term;
selecting, by the management computer, one of the plurality of physical computers whose resource amount satisfies a sum of an amount of resources allocated to a second virtual machine, which is for running the extracted service, and the amount of physical computer resources to be allocated to the first virtual machine; and
searching, by the management computer, the service combination information for a combination of services that has a chance of causing an anomaly in one of the plurality of physical computers when the combination of the extracted service and the service for which the reservation has been received is executed on the selected one of the plurality of physical computers.

4. The service reservation management method according to claim 2,
wherein the service combination information comprises a combination of services that has a chance of causing an anomaly when executed simultaneously on one of the plurality of physical computers and a period of time in which the anomaly is likely to occur, and
wherein, in the third step, when the service combination information comprises the combination of the extracted service and the service for which the reservation has been received, and the running term of the extracted service and a reservation term of the service for which the reservation has been received comprise the period of time of the service combination information, the management computer outputs an alert indicating that the combination of the extracted service and the service for which the reservation has been received has a chance of causing an anomaly when executed simultaneously on one of the physical computers.

5. The service reservation management method according to claim 1, further comprising:
a fourth step of detecting, by the management computer, an anomaly in one of the plurality of physical computers; and
a fifth step of storing, by the management computer, in the service combination information, a combination of services that have been run on the at least one virtual machine of the one of the plurality of physical computers at a time of the anomaly in one of the plurality of physical computers.

6. The service reservation management method according to claim 1,
wherein the management computer keeps a plurality of templates in which, for each service, the service and an amount of physical computer resources to be allocated to the virtual machine that executes the service are configured in advance, and
wherein, in the first step, the management computer receives one of the plurality of templates.

7. A virtual computer system, comprising:
a plurality of physical computers, each of which comprises a processor and a memory;
at least one virtual machine, which is provided by a virtualizing part executed on each of the plurality of physical computers; and
a management computer for managing a service allocated to the at least one virtual machine and the virtualizing part,
wherein the management computer comprises:
a reservation management part for receiving a reservation of the service and storing the service in reservation information; and
a resource management part for managing a configuration of the plurality of physical computers, a configuration of the at least one virtual machine, and a configuration of the service, and
wherein the reservation management part searches service combination information for storing a combination of services that has a chance of causing an anomaly in one of the plurality of physical computers and, when the service combination information comprises a combination of the received service and a service stored in the reservation information, outputs an alert indicating that the combination has a chance of causing an anomaly.

8. The virtual computer system according to claim 7,
wherein the service combination information stores a combination of services that has a chance of causing an anomaly when executed simultaneously on one of the plurality of physical computers, and
wherein the reservation management part receives the service and a running term of the service as a reservation request term, extracts a service whose running term comprised in the reservation information overlaps the reservation request term, searches the service combination information for a combination of the extracted service and the service for which the reservation has been made, and, when the service combination information comprises the combination of the extracted service and the service for which the reservation has been made, outputs an alert indicating that the combination of the extracted service and the service for which the reservation has been made has a chance of causing an anomaly when executed simultaneously on one of the plurality of physical computers.

9. The virtual computer system according to claim 8, wherein the reservation management part receives an amount of physical computer resources to be allocated to a first virtual machine for running the service for which the reservation has been received, extracts a service whose running term comprised in the reservation information overlaps the reservation request term, selects one of the plurality of physical computers whose resource amount satisfies a sum of an amount of physical computer resources allocated to a second virtual machine, which is for running the extracted service, and the amount of physical computer resources to be allocated to the first virtual machine, and searches the service combination information for a combination of services that has a chance of causing an anomaly in one of the plurality of physical computers when the combination of the extracted service and the service for which the reservation has been received is executed on the selected one of the plurality of physical computers.

10. The virtual computer system according to claim 8,
wherein the service combination information comprises a combination of services that has a chance of causing an anomaly when executed simultaneously on one of the plurality of physical computers and a period of time in which the anomaly is likely to occur, and
wherein, when the service combination information comprises the combination of the extracted service and the service for which the reservation has been received, and the running term of the extracted service and a reservation term of the service for which the reservation has been received comprise the period of time of the service combination information, the reservation management part outputs an alert indicating that the combination of the extracted service and the service for which the reservation has been received has a chance of causing an anomaly when executed simultaneously on one of the physical computers.

11. The virtual computer system according to claim 7, wherein the management computer further comprises a resource monitoring part for detecting an anomaly in one of the plurality of physical computers, and storing, in the service combination information, a combination of services that have been run on the at least one virtual machine of the one of the plurality of physical computers at a time of the anomaly in the one of the plurality of physical computers.

12. The virtual computer system according to claim 7, wherein the reservation management part keeps a plurality of templates in which, for each service, the service and an amount of physical computer resources to be allocated to the virtual machine that executes the service are configured in advance, and receives one of the plurality of templates as a service to be reserved.

13. A non-transitory computer-readable storage medium having stored thereon a program for managing a plurality of physical computers, each of which comprises a processor and a memory, at least one virtual machine, which is provided by a virtualizing part executed on each of the plurality of physical computers, a service allocated to the at least one virtual machine, and the virtualizing part, the program controlling the management computer to execute:
a first step of receiving a reservation of the service;
a second step of searching for a combination of the received service and a service of reservation information in which a service that has been already reserved is stored, by referring to service combination information for storing a combination of services that has a chance of causing an anomaly in one of the plurality of physical computers; and
a third step of outputting, when the service combination information comprises the combination of the received service and the service stored in the reservation information, an alert indicating that the combination has a chance of causing an anomaly.

14. The storage medium according to claim 13,
wherein the service combination information stores a combination of services that has a chance of causing an anomaly when executed simultaneously on one of the plurality of physical computers,
wherein, in the first step, the service and a running term of the service is received as a reservation request term,
wherein the second step comprises:
extracting a service whose running term comprised in the reservation information overlaps the reservation request term; and
searching the service combination information for a combination of the extracted service and the service for which the reservation has been received, and
wherein, in the third step, when the service combination information comprises the combination of the extracted service and the service for which the reservation has been received, an alert indicating that the combination of the extracted services and the service for which the reservation has been received has a chance of causing an anomaly when executed simultaneously on one of the plurality of physical computers is output.

15. The storage medium according to claim 14,
wherein the first step further comprises receiving an amount of physical computer resources to be allocated to a first virtual machine for running the service for which the reservation has been received, and
wherein the second step comprises:
extracting a service whose running term comprised in the reservation information overlaps the reservation request term;
selecting one of the plurality of physical computers whose resource amount satisfies a sum of an amount of physical computer resources allocated to a second virtual machine, which is for running the extracted service, and the amount of physical computer resources to be allocated to the first virtual machine; and
searching the service combination information for a combination of services that has a chance of causing an anomaly in one of the plurality of physical computers when the combination of the extracted service and the service for which the reservation has been received is executed on the selected one of the plurality of physical computers.
